(19) United States
(12) Patent Application Publication
(10) Pub. No.: US 2009/0162707 A1
(43) Pub. Date: Jun. 25, 2009

(54) PRESSURE CONTROL VALVE, METHOD OF PRODUCING PRESSURE CONTROL VALVE, FUEL CELL SYSTEM WITH PRESSURE CONTROL VALVE, AND METHOD OF CONTROLLING PRESSURE

(75) Inventors: Toru Nakakubo, Kawasaki-shi (JP); Satoshi Mogi, Yamato-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/093,650

(22) PCT Filed: Aug. 24, 2007
(86) PCT No.: PCT/JP2007/066956

§ 371 Date: May 14, 2008

(30) Foreign Application Priority Data
Aug. 29, 2006 (JP) 2006-232851

(51) Int. Cl. H01M 8/04; F16K 7/17; G05D 16/06; F16K 1/44; F16K 17/26; B21D 51/16; H01M 8/18

(52) U.S. Cl. 429/13; 137/488; 137/492.5; 137/513; 137/512.3; 29/890.12; 429/19

(57) ABSTRACT

Provided is a pressure control valve including a movable part (1) which operates by a differential pressure, a first valve (3, 4, 5) for reducing a primary pressure to a secondary pressure, a second valve (10, 11) which operates to block a flow path between an inlet flow path (12) and an outlet flow path (8) for discharging the secondary pressure when the first valve operates to open the inlet flow path (12) for introducing a fluid having the primary pressure, and a transmission mechanism (2) which links the operation of the movable part with the operations of the first and the second valves, in which either one of the movable part and the first valve is separated from the transmission mechanism.

### TECHNICAL FIELD

The present invention relates to a pressure control valve, a method of producing a pressure control valve, a fuel cell system with a pressure control valve, and a method of controlling pressure.

### BACKGROUND ART

Hitherto, when supplying fluid from a pressure vessel, a pressure reducing valve has been provided so as to reduce the pressure for supplying the fluid stably at a fixed pressure.

Further, when the pressure of a pressure vessel decreases, in order to prevent fluid from flowing backward from a flow path to the pressure vessel, a check valve is provided together with the pressure reducing valve in many cases.

In particular, Japanese Patent Application Laid-Open No. H05-039898 discloses that a pressure reducing valve and a check valve are housed in one unit for saving space.

There are various types of pressure reducing valves, and the pressure reducing valves are mainly classified into active drive pressure reducing valves and passive drive pressure reducing valves.

The active drive type pressure reducing valve is equipped with a pressure sensor, a valve driving unit, and a control mechanism, and the valve is driven so that a secondary pressure may be reduced to a set pressure.

In contrast, the passive drive type pressure reducing valve is constituted such that the valve opens and closes automatically utilizing a differential pressure when the pressure reaches a set pressure. Further, the passive type pressure reducing valve is mainly classified into a pilot type and a direct drive type. The pilot type has a pilot valve and is characterized by stable operation.

Moreover, the direct drive type is advantageous in high speed response. Further, when gas is used as working fluid, in order to surely perform the opening/closing of a valve even by a minute force of compressible fluid, a diaphragm is generally used as a differential pressure sensing mechanism.

Usually, in the direct drive diaphragm pressure reducing valve, a diaphragm, a transmission mechanism for transmitting the action of the diaphragm to a valve body, such as a piston, and the valve body are integrally connected with a screw or the like.

However, in a valve equipped with a relief mechanism as shown in Japanese Patent Application Laid-Open No. H10-268943, a diaphragm (movable part) and a transmission mechanism are separately provided for realizing a relief operation.

This is because, when a secondary pressure in a pressure reducing valve becomes higher than a predetermined pressure, the diaphragm (movable part) bends to the atmosphere side and is made distant from a piston (transmission mechanism), thereby releasing excessive pressure through a port provided in the diaphragm (movable part).

In order to realize a relief mechanism, the valve body and the transmission mechanism need to be supported by a member other than the diaphragm (movable part).

Generally, the support is achieved by providing a guide at a valve body or a periphery thereof and also by providing a coiled spring on the side opposite to the transmission mechanism relative to the valve body on a movable shaft of the transmission mechanism.

In Japanese Patent Application Laid-Open No. 2005-339321, a piston is provided with a primary regulating valve which functions as a pressure reducing valve and a secondary regulating valve which regulates the pressure by an opening/closing operation which is reverse to that of the primary regulating valve and which has pressure regulating characteristics with respect to a primary pressure change that are opposite to those of the primary regulating valve.

The secondary regulating valve, when employed for supplying fuel to a fuel cell that uses liquid fuel, closes and functions as a check valve when in disuse.

Moreover, a valve in which a plurality of valve bodies are connected and each valve body is seated on a separate valve seat is referred to as a shuttle valve.

Japanese Patent Application Laid-Open No. H05-149457, for example, discloses a specific structure of the shuttle valve.

According to Japanese Patent Application Laid-Open No. H05-149457, since two valve bodies are connected, when one valve body is seated, the other valve body opens.

As a structural example in which a pressure reducing valve is particularly reduced in size, as disclosed in Japanese Patent Application Laid-Open No. 2004-031199, a valve has been proposed which includes a diaphragm, a valve body, and a valve shaft that directly connects the valve body and the diaphragm.

As a method of producing a pressure reducing valve with such a structure, there is known a method which is disclosed in A. Debray et al, J. Micromech. Microeng. 15, S202 to S209 (2005). The production method is featured in that small mechanical elements are produced by using semiconductor processing technology.

In the semiconductor processing technology, a semiconductor substrate is used as a material and a structure is formed by combining technologies such as film deposition, photolithography, and etching.

Therefore, the semiconductor processing technology is advantageous in that fine processing of a submicron order is possible, and mass production is also easily achieved by a batch process.

In particular, because the pressure reducing valve has a complicated three-dimensional structure, there are employed reactive ion etching (ICP-RIE) for vertically etching a semiconductor substrate, bonding technology for bonding two or more semiconductor substrates and the like.

Further, a valve body and a valve seat are joined through a sacrificial layer such as of silicon oxide or the like, and, in the latter half of the process, the valve body is released from the valve seat by etching the sacrificial layer.

On the other hand, compact fuel cells are attracting attention as an energy source for mounting in a compact electric device. The fuel cell is useful as a drive source for the compact electric instrument because the energy that can be supplied per unit volume or per unit weight is several times to almost ten times that of the conventional lithium ion secondary battery.

Particularly in a fuel cell for providing a large output, it is optimum to utilize hydrogen as the fuel. However, since hydrogen is gaseous at normal temperature, there is required a technology for storing hydrogen at a high density in a small fuel tank.

The below-mentioned methods are known as the technology for such hydrogen storage.

A first method is to compress and store hydrogen in a state of high-pressure gas. When the gas pressure in a tank is set to 200 atm, the hydrogen volume density becomes about 18 mg/Cm³.

A second method is to cool hydrogen to a low temperature and to store it as a liquid. This method is capable of high-density storage, though it involves such disadvantages that a large energy is required for liquefying hydrogen and that hydrogen may spontaneously vaporize and leak.

A third method is to store hydrogen by use of a hydrogen storage alloy. This method has a problem that the fuel tank becomes heavy because the hydrogen storage alloy having a large specific gravity can absorb only about 2% by weight of hydrogen, but is effective for size reduction because the storage amount per unit volume is large.

In such a polymer electrolyte fuel cell, electric power generation is conducted in the following manner. As a polymer electrolyte membrane, a cation exchange resin based on perfluorosulfonic acid is often utilized. For such membrane, for example DuPont's Nafion is well known. A membrane electrode assembly, which is formed by interposing a polymer electrolyte membrane with a pair of porous electrodes bearing a catalyst such as platinum, namely with a fuel electrode and an oxidizer electrode, constitutes a power generating cell.

By supplying the oxidizer electrode with an oxidant and the fuel electrode with a fuel in such a power generating cell, protons move across the polymer electrolyte membrane to perform electric power generation.

The polymer electrolyte membrane generally has a thickness of about 50 to 200 μm, in order to maintain the mechanical strength and in order that the fuel gas does not permeate thereinto.

Such polymer electrolyte membrane has a strength of about 3 to 5 kg/cm².

Therefore, in order to prevent breakage of the membrane by a differential pressure, it is preferable to control a differential pressure between an oxidizer electrode chamber and a fuel electrode chamber in a fuel cell at 0.5 kg/cm² or less in an ordinary state and 1 kg/cm² or less even in an abnormal state.

In the case where the differential pressure between a fuel tank and an oxidizer electrode chamber is smaller than the above described pressure, the fuel tank and the fuel electrode chamber may be directly connected to each other without any pressure reduction.

However, in the case where an oxidizer electrode chamber is made open to the atmosphere and a fuel is filled at a higher density, it becomes necessary to reduce the pressure in the course of fuel supply from the fuel tank to the fuel electrode chamber.

Also the aforementioned mechanism is required for activation/suspension of power generation and in order to stabilize the generated electric power. Japanese Patent Application Laid-Open No. 2004-031199 discloses a technique in which a small valve is provided between a fuel tank and a fuel cell unit, thereby preventing the fuel cell unit from being broken due to a large differential pressure, also controlling activation/suspension of the power generation and stably maintaining the generated electric power. In particular, a diaphragm is provided at a boundary between a fuel supply path and an oxidizer supply path, and is directly connected to the valve to drive the valve by a differential pressure between the fuel supply path and the oxidizer supply path without utilizing an electric power, thereby realizing a pressure reducing valve, which optimally controls the fuel pressure to be supplied to the fuel cell unit.

Further, in a compact fuel cell, there is frequently used a system (dead-ended system) in which fuel is not circulated and fuel in an amount equal to the amount of consumed fuel is supplied from a fuel tank while closing an exit. However, this system has a problem that impurity gas such as nitrogen and water vapor passes through an electrolyte membrane and is accumulated in a fuel flow path, whereby the power generation characteristics are deteriorated with elapse of time.

Therefore, in the fuel cell of the dead-ended system, purging is frequently performed in order to discharge accumulated impurity gas.

On the other hand, when the remaining amount of fuel is small or the fuel tank is cooled, the pressure in the fuel tank is lowered. When the tank is replaced or the above-mentioned purging is performed in such a state, the outside air flows backward into a fuel tank due to the lowered pressure of the fuel tank.

When a fuel tank is charged with hydrogen storage alloy, the alloy surface is oxidized or poisoned, which may reduce hydrogen storage amount.

Therefore, Japanese Patent Application Laid-Open No. 2002-158020 proposes providing check valves between a fuel tank and a pressure reducing valve and between the pressure reducing valve and a fuel cell in a fuel cell system.

### DISCLOSURE OF THE INVENTION

However, in the structure in which the pressure reducing valve and the check valve are separately provided as disclosed in Japanese Patent Application Laid-Open No. H05-039898 mentioned above, the size reduction is difficult to achieve and also the production cost is high.

Moreover, as disclosed in Japanese Patent Application Laid-Open No. H10-268943 mentioned above, the pressure reducing valve equipped with a relief mechanism can take a structure in which a diaphragm (movable part) and a piston (transmission mechanism) can be separately provided.

However, the spring for closing the valve is provided on the side opposite to the piston (transmission mechanism) side of the valve body on an extension of the axis of the piston (transmission mechanism).

Therefore, the number of components for constituting the pressure reducing valve increases, which complicates the structure.

Further, in such a structure, in order to prevent positional deviation of the valve body, it is necessary to provide a guide at the valve body, the piston (transmission mechanism) or the like, in addition to the provision of the spring.

However, in the compact pressure reducing valve, it is extremely difficult to produce a compact bearing. Therefore, there is the problem that friction at the guide portion is large and it is therefore difficult to drive a valve.

Further, the components such as a coil-shaped spring, a long piston axis and the like have forms which are hard to produce using semiconductor processing technology or compact design and mass-production technology such as etching or pressing.

In other words, the structures of those components are not suitable for achieving a compact structure.

Moreover, as disclosed in Japanese Patent Application Laid-Open No. 2005-339321 mentioned above, the secondary regulating valve can function as a check valve when used for supplying fuel to a fuel cell that uses liquid fuel.

However, such a valve is a pressure regulator of a double valve type and the primary regulating valve is integrally provided to a shaft for interlocking with the secondary regulating valve, so that there is a fear that when the secondary pressure rises due to leak or the like, a stress may be applied to the shaft, thus resulting in breakage of the valve.

Such a configuration has not only a problem that the structure becomes complicated but also a problem that it is difficult to satisfy the current demand for further size reduction of a compact fuel cell system. Moreover, as the shuttle valve disclosed in Japanese Patent Application Laid-Open No. H05-149457 mentioned above, a member having the structure in which a plurality of valve bodies are connected to each other is difficult to achieve size reduction.

Moreover, in the pressure reducing valve disclosed in Japanese Patent Application Laid-Open No. 2004-031199 mentioned above, which is produced using conventional semiconductor processing technology, the diaphragm (movable part), the piston (transmission mechanism), and the valve body are integrally formed by bonding as a valve structure.

Therefore, when the secondary pressure in the pressure reducing valve excessively increases, a large stress is applied to the piston (transmission mechanism) and the valve body, which may result in breakage thereof.

In particular, because a large bonding strength is required, there is a fear that the generation rate of defective units due to poor bonding strength may increase.

Further, when there is a step of bonding a plurality of semiconductor substrates and then releasing a sacrificial layer, coating with an elastic material or the like can be carried out in order to improve the sealing property of the valve body or the valve seat surface.

However, the production process is complicated and moreover, it is difficult to provide a sealing layer in a sufficient thickness.

Further, in compact fuel cells equipped with the conventional compact pressure reducing valve, the sealing of the valve parts is insufficient, and therefore there is a fear of damaging a fuel cell by leakage.

Moreover, Japanese Patent Application Laid-Open No. 2002-158020 discloses the device equipped with check valves between the fuel tank and the pressure reducing valve and between the pressure reducing valve and the fuel cell.

However, Japanese Patent Application Laid-Open No. 2002-158020 does not disclose any specific structure thereof, and there has hitherto been no compact fuel cell with a valve that functions both as a check valve and as a pressure reducing valve.

Further, there is also a fear that because the compact pressure reducing valve is expensive, the production cost of a fuel cell may increase.

In view of the above-described problems, the present invention provides a pressure control valve which has excellent sealing characteristics and durability, which functions both as a check valve and as a pressure reducing valve, and which can achieve size reduction; a method of producing the pressure control valve; a fuel cell system equipped with the pressure control valve; and a method of controlling pressure.

The present invention provides a pressure control valve, a method of producing the pressure control valve, a fuel cell system equipped with the pressure control valve, and a method of controlling the pressure which have the below-mentioned specific features.

The pressure control valve of the present invention is characterized by including a movable part which operates by a differential pressure; a first valve for reducing a primary pressure to a secondary pressure; a second valve which operates to block a flow path between an inlet flow path and an outlet flow path for discharging the secondary pressure when the first valve operates to open the inlet flow path for introducing a fluid having the primary pressure; and a transmission mechanism which links the operation of the movable part with the operations of the first and the second valves, in which either one of the movable part and the first valve is separated from the transmission mechanism.

Further, the pressure control valve of the present invention is characterized in that the first valve includes a first valve seat, a first valve body, and a support portion for supporting the first valve body so as to create or close a gap between the first valve body and the first valve seat in accordance with an action of the movable part transmitted by the transmission mechanism.

Moreover, the pressure control valve of the present invention is characterized in that the support portion for supporting the first valve body includes an elastic body for supporting the first valve body provided on a flat plane which is perpendicular to a direction of an action of the transmission mechanism and includes the first valve body.

Further, the pressure control valve of the present invention is characterized in that the second valve is located upstream of the first valve in the flow path.

Moreover, the pressure control valve of the present invention is characterized in that the second valve is constituted by providing a second valve seat upstream of the first valve in the flow path.

Further, the pressure control valve of the present invention is characterized in that the movable part is a diaphragm.

Moreover, the pressure control valve of the present invention is characterized by being constituted by stacking the first valve and the second valve, the movable part, and the transmission mechanism each formed of a sheet-shaped member or a plate-shaped member.

The method of producing a pressure control valve of the present invention is a method of producing a pressure control valve including a movable part which operates by a differential pressure, a first valve for reducing a primary pressure to a secondary pressure, a second valve which operates to block a flow path between an inlet flow path and an outlet flow path for discharging the secondary pressure when the first valve operates to open the inlet flow path for introducing a fluid having the primary pressure, and a transmission mechanism which links the operation of the movable part with the operations of the first and the second valves, either one of the movable part and the first valve being separated from the transmission mechanism, and includes forming a movable part using one of a sheet-shaped member and a plate-shaped member; forming a transmission mechanism using one of a sheet-shaped member and a plate-shaped member; forming a first valve and a second valve using a sheet-shaped member or a plate-shaped member; and stacking the above formed components on one another to assemble a pressure control valve.

Further, the method of producing a pressure control valve of the present invention is characterized in that a semiconductor substrate is used in at least a part of the sheet-shaped member or the plate-shaped member.

Moreover, the method of producing a pressure control valve of the present invention is characterized at least one structure forming process selected from etching and pressing and at least one assembling process selected from bonding and adhesion are used in the movable part formation, the transmission mechanism formation, the first and second valve formation, and the assembling.

The fuel cell system of the present invention is characterized by including a fuel cell power generation part; a fuel flow path provided therebetween, for supplying fuel from the fuel vessel to the fuel cell power generation part; and a pressure control mechanism provided in the fuel flow path, wherein one of the pressure control valve mentioned above and the pressure control valve produced by the method as mentioned above is mounted as the pressure control mechanism.

The present invention is method of controlling pressure of the pressure control valve in the fuel cell system mentioned above, which includes adjusting a working pressure of the second valve in accordance with a set pressure of the fuel vessel.

Further, the method of controlling pressure of the present invention is characterized in that control is performed such that when the primary pressure is a pressure in a normal operation state of the fuel vessel, the secondary pressure is higher than an outside air pressure.

Moreover, the method of controlling pressure of the present invention is characterized in that control is performed such that in a case where the primary pressure is higher than a predetermined pressure, when the secondary pressure is made equal to an outside air pressure, the second valve is in an open state, while in a case where the primary pressure is lower than the predetermined pressure, when the secondary pressure is made equal to the outside air pressure, the second valve is in a closed state.

The present invention can provide the pressure control valve which has sealing properties and durability, which functions both as a check valve and as a pressure reducing valve, and which can achieve a compact structure; the method of producing such a pressure control valve; the fuel cell system with such a pressure control valve; and a method of controlling the pressure.

Further features of the present invention will become apparent from the following description of exemplary examples with reference to the attached drawings.

### BRIEF DESCRIPTION OF THE DRAWINGS

FIG. 1 is a cross-sectional view illustrating a structural example of a compact pressure reducing valve according to Example 1 of the present invention.

FIGS. 2A and 2B are views illustrating forms of a support portion of the structural example of the compact pressure reducing valve according to Example 1 of the present invention. FIG. 2A is a plan view illustrating a first form of the support portion and FIG. 2B is a plan view illustrating a second form of the support portion.

FIGS. 3A, 3B, and 3C are views illustrating operations of the compact pressure reducing valve according to Example 1 of the present invention. FIG. 3A is a cross-sectional view illustrating a state in which a first valve is closed. FIG. 3B is a cross-sectional view illustrating a state in which the first valve is opened. FIG. 3C is a cross-sectional view illustrating a state in which a second valve is closed.

FIG. 4 is a graphical representation illustrating the relationship between a primary pressure and a secondary pressure of the compact pressure reducing valve according to Example 1 of the present invention.

FIG. 5 is a cross-sectional view illustrating another form of a transmission mechanism of the structural example of the compact pressure reducing valve according to Example 1 of the present invention.

FIGS. 6A and 6B are cross-sectional views illustrating examples of application of the compact pressure reducing valve of the structural example according to Example 1 of the present invention.

FIG. 7 is an exploded perspective view illustrating the structural example of the compact pressure reducing valve according to Example 1 of the present invention.

FIGS. 8A, 8B, 8C, and 8D are views illustrating respective units of the structural example of the compact pressure reducing valve according to Example 1 of the present invention. FIG. 8A is a plan view illustrating a unit having a piston of the structural example of the compact pressure reducing valve according to Example 1 of the present invention. FIG. 8B is a plan view illustrating a unit having a flow path below a lower surface of a diaphragm of the structural example of the compact pressure reducing valve according to Example 1 of the present invention. FIG. 8C is a plan view illustrating a unit having a valve seat of the structural example of the compact pressure reducing valve according to Example 1 of the present invention. FIG. 8D is a plan view illustrating a unit having a valve body of the structural example of the compact pressure reducing valve according to Example 1 of the present invention.

FIGS. 9A, 9B, 9C, 9D, 9E, 9F, 9G, 9H, 9I, 9J, 9K, 9L, 9M, and 9N are cross-sectional views illustrating steps of production procedure of the compact pressure reducing valve according to Example 1 of the present invention.

FIG. 10 is a cross-sectional view illustrating a structural example of a compact pressure reducing valve according to Example 2 of the present invention.

FIG. 11 is a cross-sectional view illustrating a structure of a spacer and a second seat valve of the compact pressure reducing valve according to Example 2 of the present invention.

FIGS. 12A, 12B, and 12C are views illustrating operations of the compact pressure reducing valve of Example 2 of the present invention. FIG. 12A is a cross-sectional view illustrating a state in which a first valve is closed. FIG. 12B is a cross-sectional view illustrating a state in which the first valve is opened. FIG. 12C is a cross-cross-sectional view illustrating a state in which a second valve is closed.

FIG. 13 is a cross-sectional view illustrating another form of a transmission mechanism of the structural example of the compact pressure reducing valve according to Example 2 of the present invention.

FIG. 14 is an exploded perspective view illustrating the structural example of the compact pressure reducing valve according to Example 2 of the present invention.

FIGS. 15A, 15B, 15C, and 15D are views illustrating respective units of the structural example of the compact pressure reducing valve according to Example 2 of the present invention. FIG. 15A is a plan view illustrating a unit having a piston of the structural example of the compact pressure reducing valve according to Example 2 of the present invention. FIG. 15B is a plan view illustrating a unit having a flow path below a lower surface of a diaphragm of the structural example of the compact pressure reducing valve according to Example 2 of the present invention. FIG. 15C is a plan view illustrating a unit having a valve seat of the structural example of the compact pressure reducing valve according to Example 2 of the present invention. FIG. 15D is a plan view illustrating a unit having a valve body of the structural example of the compact pressure reducing valve according to Example 2 of the present invention.

FIGS. 16A, 16B, 16C, 16D, 16E, 16F, 16G, 16H, 16I, 16J, 16K, 16L, 16M, 16N, 160, 16P, and 16Q are cross-sectional views illustrating steps of production procedure of a first method of producing a compact pressure reducing valve according to Example 2 of the present invention.

FIGS. 17A, 17B, 17C, 17D, 17E, 17F, 17G, 17H, 17I, 17J, and 17K are cross-sectional views illustrating steps of production procedure of a second method of producing a compact pressure reducing valve according to Example 2 of the present invention.

FIG. 18 is a perspective view illustrating a fuel cell according to Example 3 of the present invention.

FIG. 19 is a schematic diagram illustrating a fuel cell system according to Example 3 of the present invention.

FIG. 20 is a schematic cross-sectional view illustrating the positional relationship of the compact pressure reducing valve in the fuel cell system according to Example 3 of the present invention.

FIGS. 21A, 21B, and 21C are diagrams illustrating purging in the fuel cell according to Example 3 of the present invention.

FIG. 22 is a diagram illustrating the setup of the working pressure in the fuel cell according to Example 3 of the present invention.

FIG. 23 is a table illustrating the dissociation pressures of hydrogen storage alloy (LaNi₅) in the fuel cell system according to Example 3 of the present invention.

### BEST MODE FOR CARRYING OUT THE INVENTION

The best mode for carrying out the present invention will be described according to the following examples.

### Example 1

In Example 1, a first structural example of a compact pressure reducing valve, to which the present invention is applied, will be described.

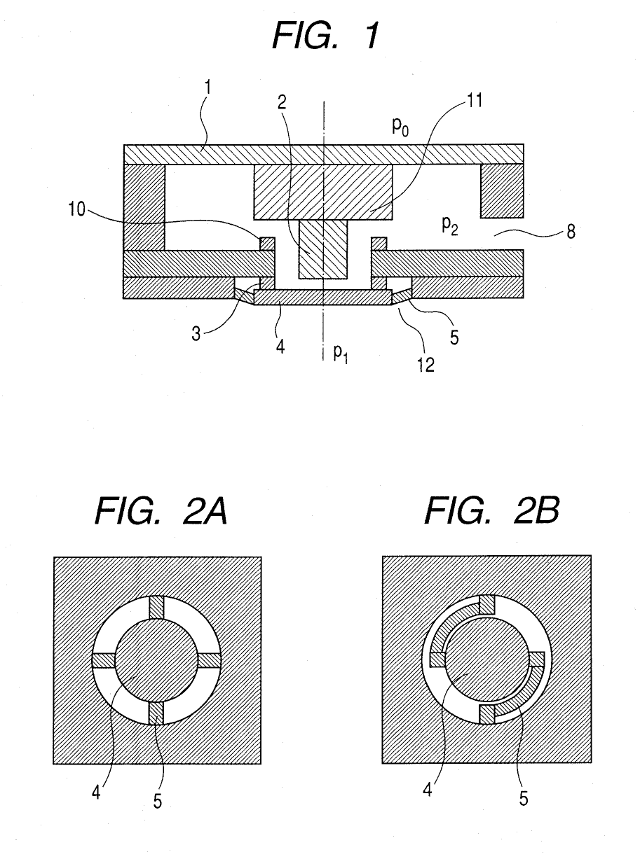

FIG. 1 is a cross-sectional view illustrating a structural example of a compact pressure reducing valve according to this Example of the present invention.

In FIG. 1, reference numerals 1, 2, 3, 4, 5, 8, 10, 11, and 12 denote a diaphragm, a piston, a first valve seat, a first valve body, a support portion, an outlet flow path, a second valve seat, a second valve body, and an inlet flow path, respectively.

The pressure reducing valve of this example includes the diaphragm 1 which serves as a movable part; the piston 2 which is a transmission mechanism; a first valve seat 3, a first valve body 4, and a support portion 5 which form a first valve; a second valve seat 10 and a second valve body 11 which form a second valve; an inlet flow path 12; and an outlet flow path 8.

In particular, the first valve body 4 is circumferentially supported by the support portion 5.

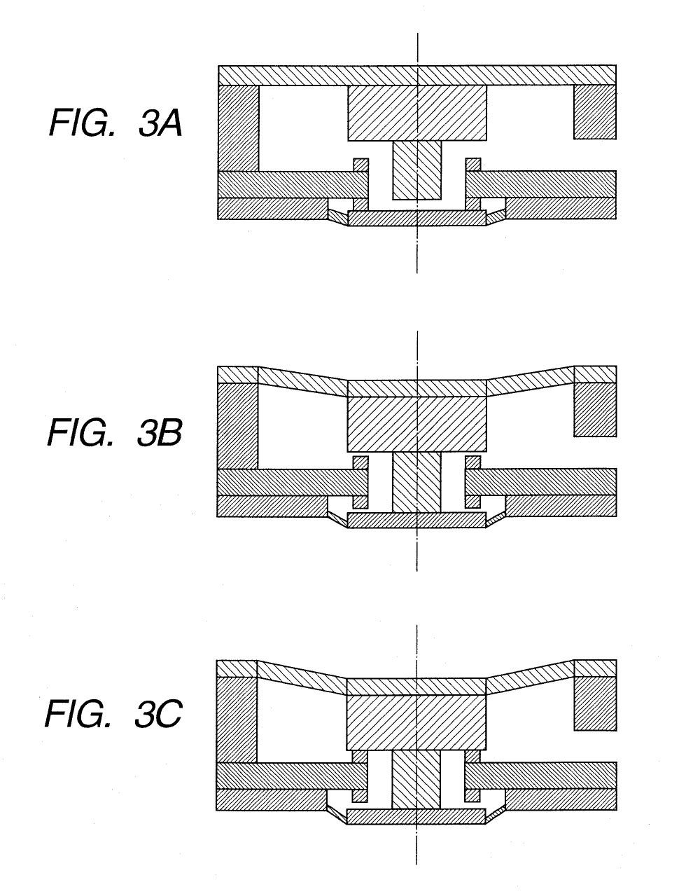

The support portion 5 is formed of a beam having elasticity, and can take structures as shown in, for example, FIGS. 2A and 2B.

When a structure is used in which the first valve seat 3 projects from its surroundings, the pressure applied to a valve opening/closing portion is increased to bend a spring of the support portion while the valve is closed, thereby improving the sealing property.

Further, the sealing property can be improved by coating the surface of at least one of the valve body and the valve seat with a sealing material for a valve.

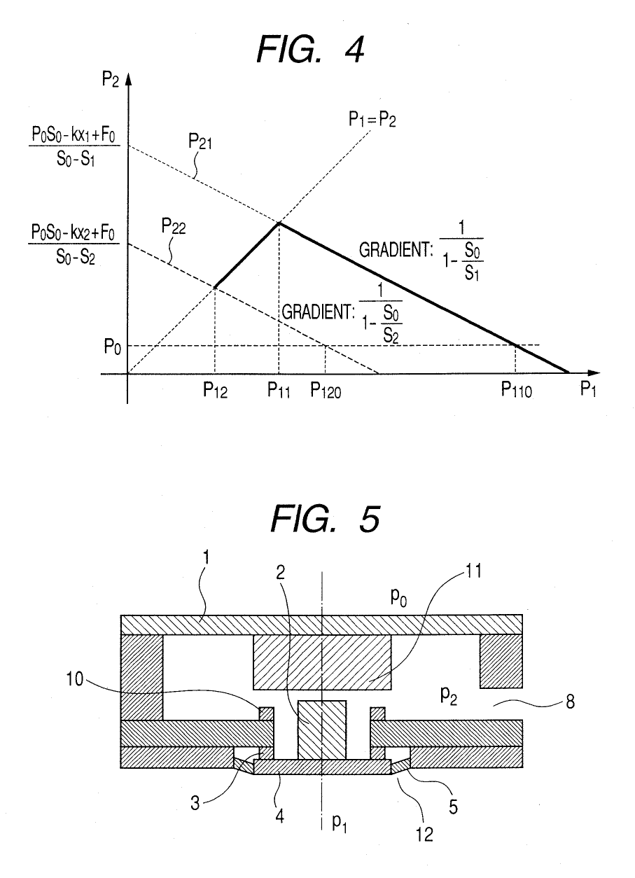

Hereinafter, the operation of the pressure reducing valve will be described with reference to FIGS. 1, 3A, 3B and 3C.

The pressure at a location above the diaphragm (movable part) 1 is defined as P₀, a primary pressure at upstream of the valve is defined as P₁, a pressure at downstream of the valve is defined as P₂, the opening area of the first valve body 4 is defined as S₁, the opening area of the second valve seat 10 is defined as S₂, and the area of the diaphragm (movable part) 1 is defined as S₀. The spring constant is defined as k, and the displacement amount is defined as x. At this time, the condition under which the first valve body 4 opens is expressed by the following equation based on the balance of the pressures.

(P₀−P₂)−kx+F₀>P₁S₁−P₂S₁

On the other hand, the condition under which the second valve body 11 opens is expressed by the following equation.

(P₀−P₂)−kx+F₀>P₁S₂−P₂S₂

When the respective pressures are, respectively, defined as P₂₁ and P₂₂, the following equation is established.

$${P}_{21} = \frac{{P}_{0} {S}_{0} - {P}_{1} {S}_{1} - {kx}_{1} + {F}_{0}}{{S}_{0} - {S}_{1}}$$

$${P}_{22} = \frac{{P}_{0} {S}_{0} - {P}_{1} {S}_{2} - {kxx}_{2} + {F}_{0}}{{S}_{0} - {S}_{2}}$$

Incidentally, x₁ and x₂ each represent a displacement of the diaphragm 1 when each valve is closed. Therefore, the operation of the valve due to changes in the pressure P₂ are as shown in FIGS. 3A to 3C.

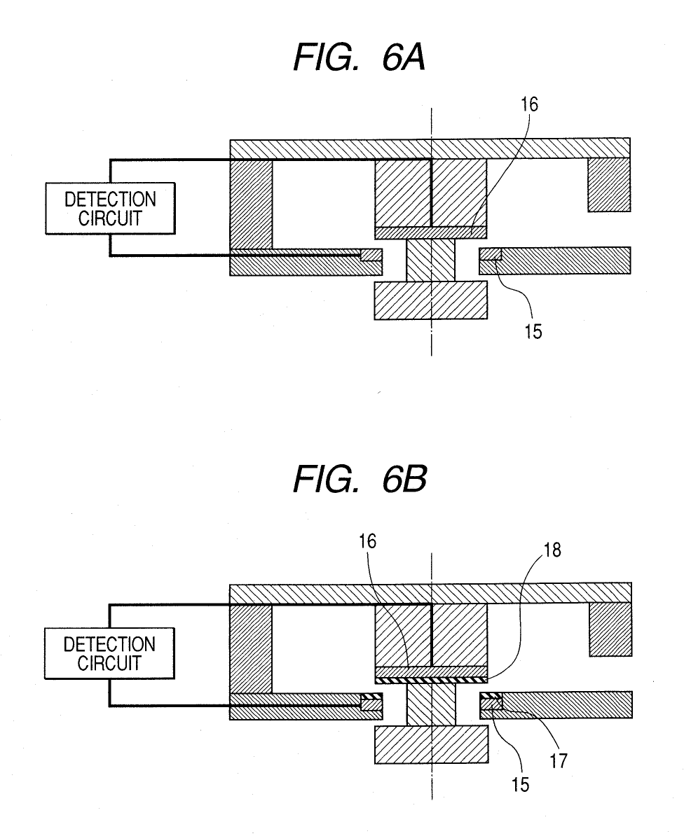

More specifically, in the case of P₂>P₂₁, the first valve closes (FIG. 3A); in the case of P₂₂<P₂<P₂₁, the valves open (FIG. 3B); and in the case of P₂<P₂₂, the second valve closes (FIG. 3C). The pressures P₂₁ and P₂₂ change when the pressure P₁ changes. FIG. 4 is a graph illustrating the changes in the pressures P₂₁ and P₂₂ when the pressure P₁ changes.

It can be seen that both the pressures P₂₁ and P₂₂ decrease as the pressure P₁ increases. When the pressure P₁ is sufficiently high, the controlled secondary pressure P₂ is on the line of P₂₁. However, when the pressure P₁ decreases, the pressures P₁ and P₂ become equal. When the pressure P₁ further decreases, P₂ crosses the line of P₂₁, and the second valve closes. Thus, the change in the pressure P₂ is expressed by the solid line of the graph.

The pressure at which the valve opens/closes and the flow rate can be optimally adjusted by adjusting the area of the first valve body 4, the area of the diaphragm (movable part) 1, the length of the piston (transmission mechanism) 2, the thickness of the diaphragm (movable part) 1, and the form of the beam of the support portion 5.

In particular, when the spring constant of the diaphragm (movable part) 1 is larger than the spring constant of the support portion 5, the pressure at which the valve opens depends on the diaphragm (movable part) 1.

In contrast, when the spring constant of the support portion 5 is larger than the spring constant of the diaphragm (movable part) 1, the behavior of the valve depends on the support portion 5.

The sealing property of the valve and the pressure at which the valve operates change depending on the height of a projection of the first valve body 4.

The pressure P₂₂ can be adjusted by optimally determining the length of the piston (transmission mechanism) 2 from the second valve body 11 to the first valve body 4.

On the other hand, when the pressure P₂ at downstream of the valve becomes higher than a set pressure, the diaphragm (movable part) 1 bends upward to close the valve.

At this time, because the piston (transmission mechanism) 2 is not bonded to the first valve body 4, the first valve body 4 stops when contacting the first valve seat 3. Thus, only the piston (transmission mechanism) 2 moves together with the diaphragm (movable part) 1.

This can prevent the valve from being damaged by increase in the pressure.

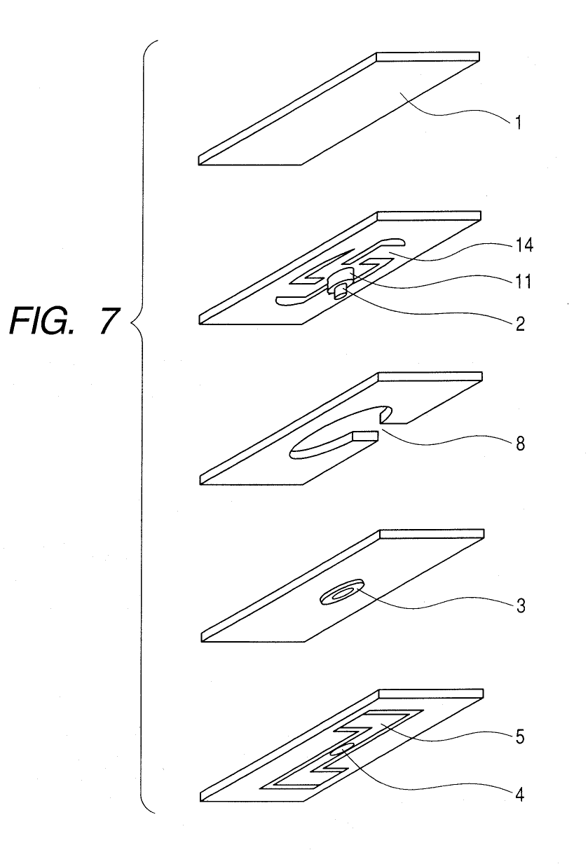

Further, as shown in FIG. 5, the pressure reducing valve can be structured in such a manner that the piston 2 is integrally joined to the first valve body 4, and is separated from the diaphragm 1.

Also in this case, the principle of the operation is the same as that of the structure shown in FIG. 1.

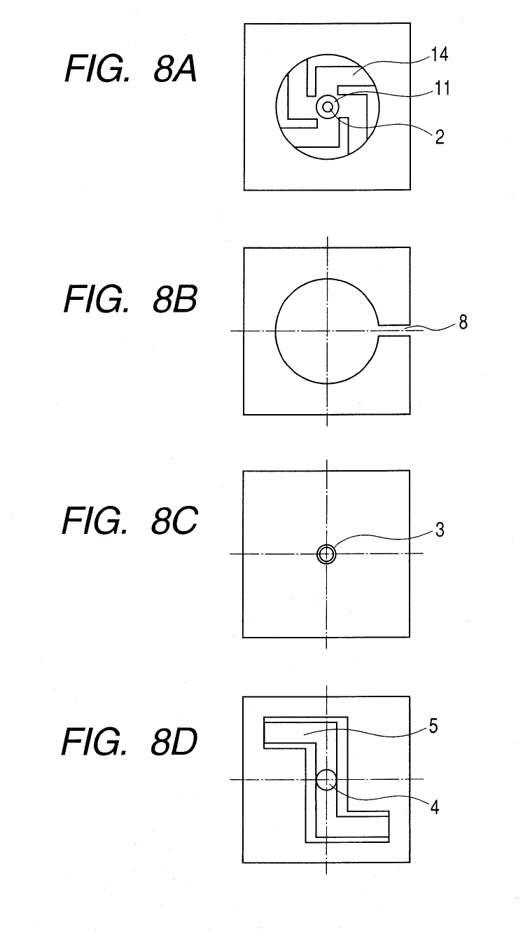

Further, as shown in FIG. 6A, the opening/closing state of the valve can be confirmed by providing electrodes on the valve seat and on the valve body, and providing a detection circuit for detecting the contact state between the both electrodes.

Further, as shown in FIG. 6B, the valve opening can also be confirmed by providing an insulating layers on the electrode surfaces and providing a detection circuit for detecting the amount of electricity stored between the both electrodes.

The pressure reducing valve of this example can be produced, for example, using mechanical processing technologies as follows.

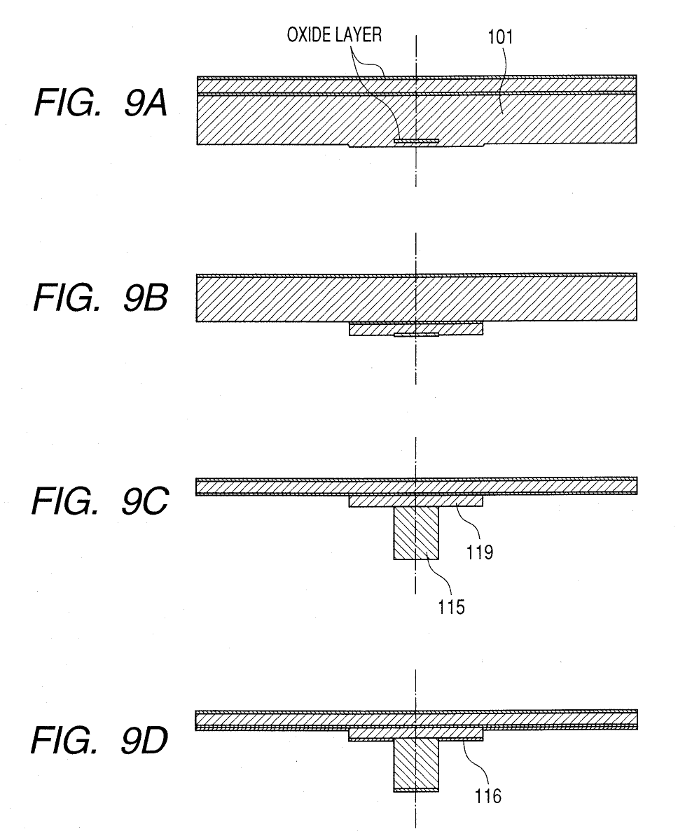

FIG. 7 is an exploded perspective view when the pressure reducing valve is viewed from the first valve body 4 side.

As shown in the perspective view, the pressure reducing valve is produced by stacking sheet-shaped members or plate-shaped members.

The size of each member is 8 mm×8 mm.

For the diaphragm (movable part) 1, elastic materials such as Viton rubber and silicone rubber, metallic materials such as stainless steel (SUS) and aluminum, plastics, etc., can be used.

For example, when stainless steel is used as a material for the diaphragm 1, the piston can be made integrally with the diaphragm 1 by etching, cutting, etc.

In this example, a hot melt sheet (manufactured by NITTO SHINKO CORPORATION) having a 25 μm thick adhesive layer with gas sealing property on a 50 μm thick PET base material was used for the diaphragm 1.

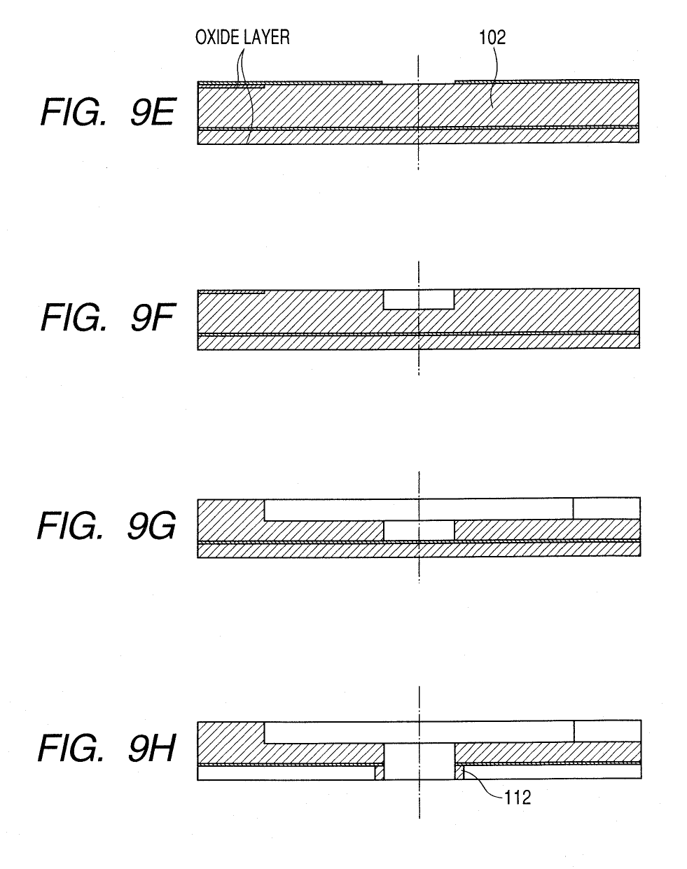

The piston portion was produced by etching a stainless steel body in which a diaphragm support portion 14, the second valve body 11, and the piston 2 were integrally formed as shown in the plan view of FIG. 8A.

The thickness of the diaphragm support portion 14 is 50 μm and the height of the piston 2 is 250 μm. The hot melt sheet and the stainless steel member were heated to about 140° C. and held at that temperature for several seconds while they were superimposed on each other, thereby effecting adhesion therebetween.

A space below the diaphragm (movable part) 1 and a flow path through which the piston (transmission mechanism) 2 passes can be formed by mechanical processing or etching of a stainless steel body.

The mechanical processing such as cutting and etching can be applied for the processing.

In this example, a hot melt sheet (manufactured by NITTO SHINKO CORPORATION) having a 25 μm thick adhesive layer with gas sealing property on both sides of a 50 μm thick PET base material was used for forming the space below the diaphragm (movable part) 1. This is shown in the plan view of FIG. 8B.

The flow path through which the piston (transmission mechanism) 2 passes can be made by mechanical processing or etching of a stainless steel body. This is shown in the plan view of FIG. 8C.

A 250 μm thick stainless steel plate was etched, and the projection height of the first valve seat 3 was set to 100 μm. It is not necessarily needed to form a projection on the second valve seat 10. The height of the projection was set to 10 μm by etching from the rear side.

Coating of a sealing material to the valve seat or the valve body may be performed by vapor deposition of Parylene or Teflon (trade names), or the like, or by applying, by spin coating or spraying, silicone rubber, polyimide, Teflon (trade name) material, or the like.

In this example, silicone rubber was applied to the surface of the both sides of a member of FIG. 8C having a valve seat by spin coating (3000 RPM×30 seconds), thereby obtaining a uniform sealing layer with a thickness of about 40 μm.

The hot melt sheet-shaped member for forming the space below the movable part 1 and the stainless steel (SUS) member having the flow path through which the piston (transmission mechanism) 2 passes were heated in a superimposed state to about 140° C. and held at that temperature for several seconds to be adhered to each other.

A member having the support portion 5 and the first valve body can be produced by mechanical processing or etching of a stainless steel body. FIG. 8D is a plan view of this member.

This member was obtained by etching a 200 μm thick SUS member. The thickness of the support portion 5 was 50 μm.

In the production method of this pressure reducing valve, two-stage etching of stainless steel is frequently performed. Two-stage etching is accurately and easily performed by forming different masks on the front surface and the rear surface and by etching from the both sides.

In the pressure reducing valve produced as described above, when the atmospheric pressure is about 1 atm, in the case where the primary pressure is equal to or more than 1 atm, the secondary pressure is about 0.8 atm (absolute pressure).

Further, the pressure reducing valve produced as described above has leakage characteristics of 0.1 sccm or less and is not damaged even when the secondary pressure is 2.5 atm (absolute pressure). Further, when the primary pressure decreases, the second valve closes.

In this example, a hot melt sheet is used for adhesion.

This method is excellent in controlling thickness or positioning. In addition, a method of applying another adhesive or a method of utilizing diffusion bonding of metals is also effective.

Further, because each member is in the form of a sheet, etching and pressing are suitable for processing of a metal member, and pressing and injection molding are suitable for processing of a resin member.

Further, members made by utilizing semiconductor processing technologies described in the below-mentioned examples can be used for a part or all of the members described in this example.

Next, a method of producing the compact pressure reducing valve in this example using semiconductor processing technology will be described.

The compact pressure reducing valve produced according to this example has a structure such that the transmission mechanism (piston) 2 is integrally formed with the diaphragm (movable part) 1 as shown in FIG. 1 and is separated from the first valve body 4.

The dimension of each part of the compact pressure reducing valve produced in this example can be set as follows, but can be changed according to designs.

The diaphragm (movable part) can be adjusted to be 3.6 mm in diameter and 40 μm in thickness.

The piston (transmission mechanism) can be adjusted to be 260 μm in diameter and 200 to 400 μm in length.

The piston passing flow path can be adjusted to be 400 μm in diameter.

The projection can be adjusted to be 20 μm in width and 10 μm in height, the sealing layer can be adjusted to be 5 μm in thickness, and the valve body can be adjusted to be 1000 μm in diameter and 200 μm in thickness.

The support portion can be adjusted to be 1000 μm in length, 200 μm in width, and 10 μm in thickness.

Next, a specific method of producing the compact pressure reducing valve in this example will be described.

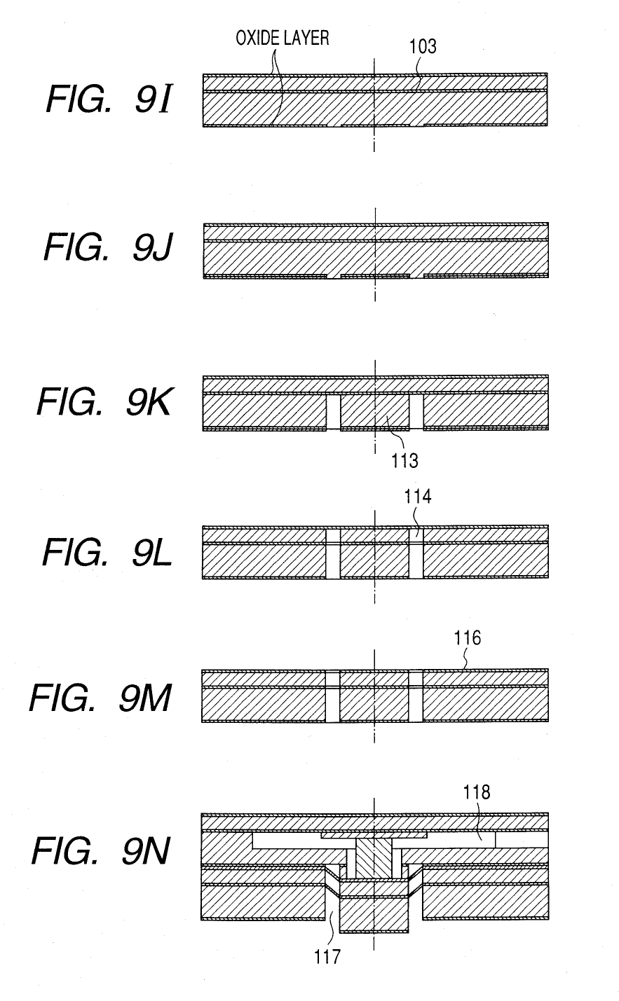

FIGS. 9A to 9N illustrate steps of the production procedure of the compact pressure reducing valve according to this example of the present invention.

The first step shown in FIG. 9A is a mask patterning step for etching.

A silicon wafer having one side thereof polished is also usable for a first silicon wafer 101. However, it is desirable to use a silicon wafer having both sides thereof polished.

Further, in an etching step below, in order to control the etching depth, it is desirable to use a silicon-on-insulator (SOI) wafer.

Further, in order to improve the flatness of a portion of the second valve body 119 to be in contact with the valve seat, it is preferable to use a double SOI wafer with two oxide layers.

For the silicon wafer, a silicon wafer having a 500 μm thick handle layer, a 1 μm thick oxide layer (BOX layer), and a 40 μm thick device layer can be used.

For use as an etching mask, the front surface of the first wafer 101 is thermally oxidized.

The first wafer is placed in a furnace, and hydrogen and oxygen are flowed at predetermined flow rates in the furnace heated to about 1000° C. to thereby form an oxide layer on the wafer surface.

Next, in order to perform two-stage etching in this step and the subsequent step, a mask with a two-layer structure having a silicon oxide layer and a photoresist layer is produced.

First, the front surface of the wafer is protected by a photoresist.

Then, a photoresist is spin coated on the rear surface of the wafer, pre-baked, and exposed to light. Then, patterning for forming a flow path below the lower surface of the diaphragm (movable part) is performed.

Further, development and post-baking are performed. The oxide layer is etched with hydrofluoric acid using the photoresist as a mask. Further, a mask for forming the second valve body 119 is patterned.

More specifically, the photoresist is spin coated, pre-baked, exposed to light, developed, and post-baked.

In this example, the photoresist and the silicon oxide layer were used as a two-layer mask. However, this process can be performed by using silicon oxide layers having different thicknesses, or using an aluminum layer.

A second step shown in FIG. 9B is a step of forming a support portion of the transmission mechanism by reactive ion etching (ICP-RIE).

The etching depth is controlled by adjusting the etching time, and etching of about 190 μm is performed.

Finally, the photoresist mask is removed with acetone.

At this time, when the double SOI wafer is used, the oxide layer can be used as an etch stop layer.

A third step shown in FIG. 9C is a step of producing a diaphragm (movable part) 111 and a transmission mechanism 115.

A wafer is etched by reactive ion etching (ICP-RIE).

The etching depth may be controlled by adjusting the etching time, or an oxide layer (BOX layer) of an SOI wafer may be used as an etch stop layer as shown in figure.

The silicon oxide layer used for the mask is removed with hydrofluoric acid.

As described above, in this example, two-stage etching using a two-layer mask was performed in order to form the support portion between the transmission mechanism and the diaphragm (movable part). However, depending on a required spring constant, the support portion is not required. In such a case, a single-layer mask suffices as the mask used in this example and the second step is not required.

A fourth step shown in FIG. 9D is a step of coating a sealing surface.

As shown in FIG. 9D, the coating may be performed on the valve body side or on the valve seat side. Examples of a coating material include Parylene, CYTOP, polytetrafluoroethylene (PTFE), polyimide, etc.

Parylene and PTFE can be applied by vapor deposition and CYTOP and polyimide can be applied by spin coating. In addition, spray coating can also be used.

The fifth step shown in FIG. 9E is a mask patterning step for etching.

It is desirable to use a silicon wafer having both sides thereof polished for a second silicon wafer 102. Further, in an etching step described below, in order to control the etching depth, it is desirable to use a silicon-on-insulator (SOI) wafer.

Further, in order to improve the flatness of a portion of the second valve body to be in contact with the valve seat, it is preferable to use a double SOI wafer with two oxide layers.

For the silicon wafer, a silicon wafer having a 500 μm thick handle layer, a 1 μm thick oxide layer (BOX layer), and a 40 μm thick device layer can be used by turning over the silicon wafer so that the handle layer is positioned at the top in the figure.

For use as an etching mask, the front surface of the second wafer 102 is thermally oxidized.

The second wafer is placed in a furnace, and hydrogen and oxygen are flowed at predetermined flow rates into the furnace heated at about 1000° C. to thereby form an oxide layer on the wafer surface.

Next, in order to perform two-stage etching in this step and the subsequent step, a mask with a two-layer structure having a silicon oxide layer and a photoresist layer is produced.

First, the rear surface of the wafer is protected by a photoresist.

Then, a photoresist is spin coated, pre-baked, and exposed to light. Then, patterning for forming a flow path under the lower surface of the diaphragm (movable part) is performed.

Further, development and post-baking are performed. The oxide layer is etched with hydrofluoric acid using the photoresist as a mask. Further, a mask for a flow path around the transmission mechanism 115 is patterned.

More specifically, the photoresist is spin coated, pre-baked, exposed to light, developed, and post-baked.

In this example, the photoresist and the silicon oxide layer were used as a two-layer mask. However, this process can be performed by using silicon oxide layers having different thicknesses, or using an aluminum layer.

A sixth step shown in FIG. 9F is a step of forming a support portion of the transmission mechanism by reactive ion etching (ICP-RIE). The etching depth is controlled by adjusting the etching time, and etching of about 200 μm is performed. Finally, the photoresist mask is removed with acetone. At this time, when the double SOI wafer is used, the oxide layer can be used as an etch stop layer.

The secondary pressure at which the second valve body 119 closes is determined based on the relationship between the etching depth in this sixth step and the etching depth in the second step.

A seventh step shown in FIG. 9G is a step of forming a flow path below the lower surface of the diaphragm (movable part).

A wafer is etched by reactive ion etching (ICP-RIE). The etching depth may be controlled by adjusting the etching time, or an oxide layer (BOX layer) of an SOI wafer may be used as an etch stop layer.

The secondary pressure at which the second valve 119 closes is determined by a relationship of etching depth between the sixth step and the second step.

A seventh step shown in FIG. 9G is a step of forming a valve seat 112.

A photoresist is spin coated on the rear surface of the wafer, pre-baked, and exposed to light. A silicon oxide layer is etched with hydrofluoric acid and patterned.

Etching is performed by reactive ion etching (ICP-RIE), to thereby form a valve seat 112. When an SOI wafer is used for the first wafer 101, a middle oxide layer can be used as an etch stop layer; the height of the projection of the valve seat can be precisely adjusted; and the front surface after etching can be kept flat. After etching, the mask is removed with hydrofluoric acid.

An eighth step shown in FIG. 9H is a mask patterning step for etching using a third silicon wafer 103.

A silicon wafer having one side thereof polished is usable for the third silicon wafer 103. However it is desirable to use a silicon wafer having both sides thereof polished.

Further, in an etching step below, in order to control the etching depth, it is desirable to use a silicon-on-insulator (SOI) wafer.

For the silicon wafer, a silicon wafer having a 200 μm thick handle layer, a 1 μm thick oxide layer (BOX layer), and a 10 μm thick device layer can be used.

For use as an etching mask, the surface of the third wafer 103 is thermally oxidized. The third wafer is placed in a furnace, and hydrogen and oxygen are flowed at predetermined flow rates in the furnace heated at about 1000° C. to thereby form an oxide layer on the wafer surface.

Next, the front surface of the wafer is protected by a photoresist, and then, patterning for forming the valve body on the rear surface is performed. Subsequently, the photoresist is spin coated, pre-baked, and exposed to light.

Further, development and post-baking are performed. The oxide layer is etched with hydrofluoric acid using the photoresist as a mask.

The photoresists on the front surface and the rear surface are removed with acetone. In this step, photoresist or aluminum besides a silicon oxide can be used for a mask.

A ninth step shown in FIG. 9I is a step of patterning a mask for forming a support portion 114.

The rear surface of the wafer is protected by a photoresist, and then, patterning for forming the support portion on the front surface of the wafer is performed. The photoresist is spin coated, pre-baked, and exposed to light.

Further, development and post-baking are performed. Using the photoresist as the mask, an oxide layer is etched with hydrofluoric acid. The photoresists on the front surface and the rear surface are removed with acetone.

A tenth step shown in FIG. 9J is a step of forming a first valve body 113.

The rear surface of a wafer is etched by reactive ion etching (ICP-RIE). The etching depth may be controlled by adjusting the etching time, or an oxide layer (BOX layer) of an SOI wafer may be used as an etch stop layer.

An eleventh step shown in FIG. 9K is a step of forming a support portion.

The front surface of a wafer is etched by reactive ion etching (ICP-RIE).

When an SOI wafer is used, the thickness of a support portion can be precisely controlled at this time, so that a support portion with less spring constant error can be obtained. After etching, the oxide layer used for the mask is removed with hydrofluoric acid.

A twelfth step shown in FIG. 9L is a step of coating a sealing surface. As shown in FIG. 9L, the coating may be performed either on the valve body side or on the valve seat side. Examples of a coating material include Parylene, CYTOP, PTFE (polytetrafluoroethylene), polyimide, etc.

Parylene and PTFE can be applied by vapor deposition, and CYTOP and polyimide can be applied by spin coating. In addition, spray coating can also be used.

A thirteenth step shown in FIG. 9M is an assembling step.

A compact pressure reducing valve is completed by stacking the member having the diaphragm (movable part) 111 and the valve seat 112 which was produced by the first to sixth steps, and the member having the first valve body 113 which was produced by the seventh to eleventh steps (FIG. 9N).

### Example 2

In Example 2, a second structural example of a compact pressure reducing valve, to which the present invention is applied, will be described.

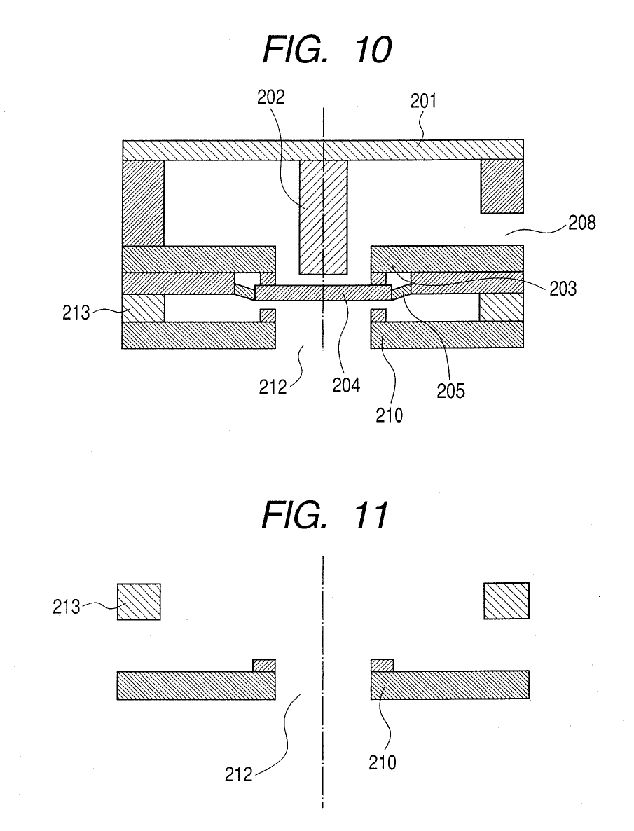

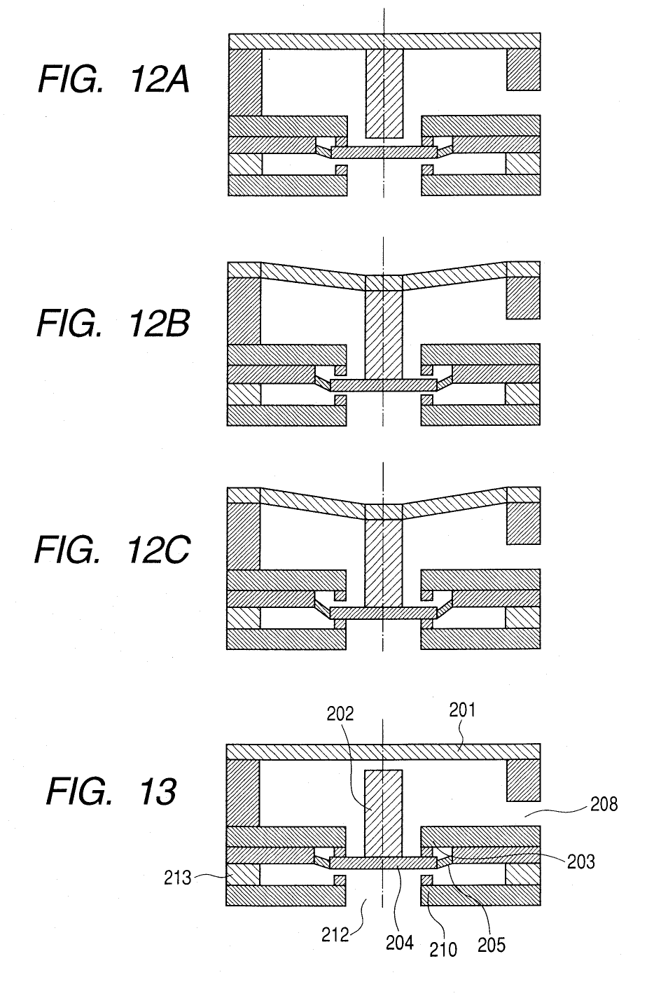

FIG. 10 is a cross-sectional view illustrating a structural example of a compact pressure reducing valve according to this Example of the present invention.

In FIG. 10, reference numerals 201, 202, 203, 204, 205, 208, 210, 212, and 213 denote a diaphragm, a piston, a first valve seat, a first valve body, a support portion, an outlet flow path, a second valve seat, an inlet flow path, and a spacer, respectively.

The pressure reducing valve in this example includes the diaphragm 201 which serves as a movable part, the piston 202 which is a transmission mechanism, a first valve seat 203, a valve body 204, a support portion 205, a second valve seat 210, an inlet flow path 212, an outlet flow path 208, and a spacer 213.
In particular, the valve body 204 is circumferentially supported by the support portion 205 and each of the upper surface and the lower surface sides can be seated on the first valve seat 203 and the second valve seat 210, respectively.

The support portion 205 is formed of a beam having elasticity, and can take structures as shown in, for example, FIGS. 2A and 2B.

When a structure is used in which the first valve seat 203 is higher than its surroundings, the pressure applied to a valve opening/closing portion is increased to bend a spring of the support portion while the valve is closed, thereby improving the sealing property. Further, the sealing property can be improved by coating the surface of at least one of the valve body and the valve seat with a sealing material for a valve.

The structure of this example is different from that of Example 1 mainly in that the second valve that has a function of counterflow prevention is located upstream of the first valve that has a function of a pressure reduction, and also in that the first valve body and the second valve body are integrally joined to form a single unit.

Such a structure has an advantage in that a pressure reducing valve having the functions of the present invention can be easily produced by stacking sheet-shaped structures or plate-shaped structures.

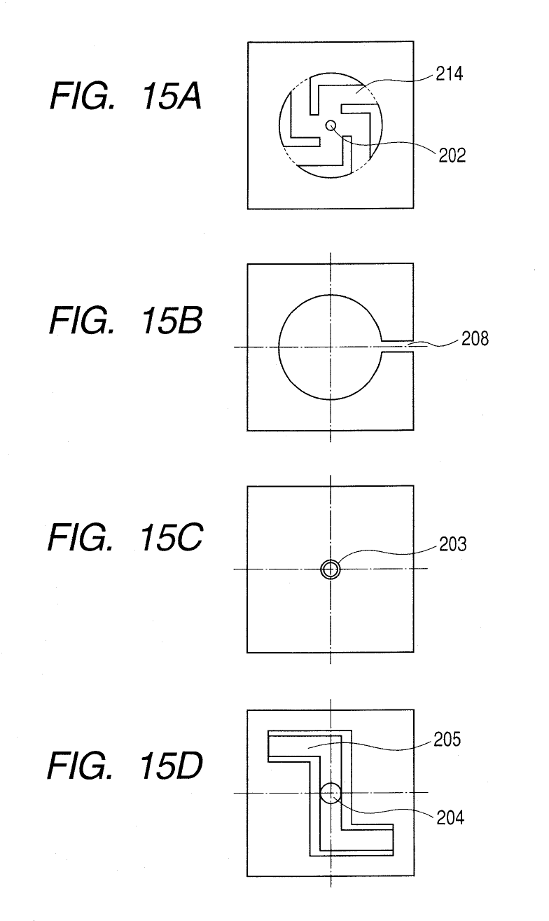

Moreover, there is also an advantage that the functions of the present invention can be attained simply by adding a member having the spacer 213 and the second valve seat 210 to an existing compact pressure reducing valve as shown in FIG. 13.

Hereinafter, the operation of the pressure reducing valve will be described with reference to FIG. 10.

The pressure at a location above the diaphragm (movable part) 201 is defined as P₀, the primary pressure at upstream of the valve is defined as P₁, and the pressure at downstream of the valve is defined as P₂.

Further, the opening area of the first valve body 204 is defined as S₁, the opening area of the second valve seat 210 is defined as S₂, the area of the diaphragm (movable part) 201 is defined as S₀, the spring constant is defined as k, and the displacement amount is defined as x. At this time, the condition under which the first valve body 204 opens is expressed by the following equation based on the balance of the pressures.

(P₀−P₂)−kx+F₀>P₁S₁−P₂S₁

On the other hand, the condition under which the second valve seat 210 opens is expressed by the following equation.

(P₀−P₂)−kx+F₀>P₁S₂−P₂S₂

When the pressures are, respectively, defined as P₂₁, and P₂₂, the following equation is established.

$${P}_{21} = \frac{{P}_{0} {S}_{0} - {P}_{1} {S}_{1} - {kxx}_{1} + {F}_{0}}{{S}_{0} - {S}_{1}}$$

$${P}_{22} = \frac{{P}_{0} {S}_{0} - {P}_{1} {S}_{2} - {kx}_{2} + {F}_{0}}{{S}_{0} - {S}_{2}}$$

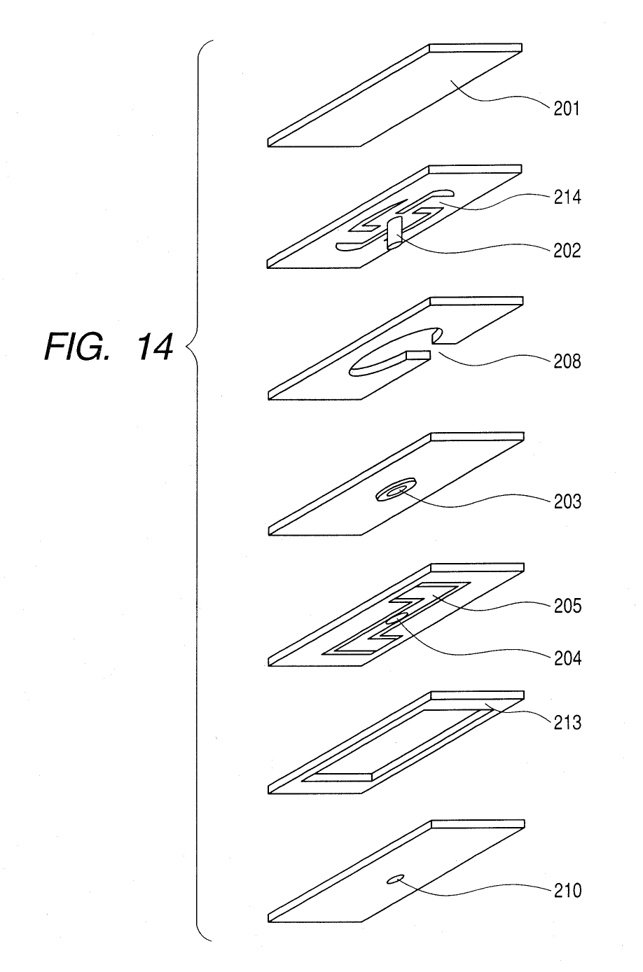

Incidentally, x₁ and x₂ each represent displacement of the diaphragm 201 when each valve is closed. Therefore, the operation of the valve due to changes in the pressure P₂ are as shown in FIGS. 12A to 12C. More specifically, in the case of P₂>P₂₁, the first valve closes (FIG. 12A); in the case of P₂₂<P₂<P₂₁, the valves open (FIG. 12B); and in the case of P₂<P₂₂, the second valve closes (FIG. 12C).

The pressures P₂₁ and P₂₂ change when the pressure P₁ changes. FIG. 4 is a graph illustrating the changes in the pressures P₂₁ and P₂₂ when the pressure P₁ changes.

It can be seen that the both pressures P₂₁ and P₂₂ decrease as the pressure P₁ increases. When the pressure P₁ is sufficiently high, the controlled secondary pressure P₂ is on the line of P₂₁. However, when the pressure P₁ decreases, the pressures P₁ and P₂ become equal. When the pressure P₁ further decreases, P₂ crosses the line of P₂₁, and the second valve closes. Thus, the changes in the pressure P₂ are expressed by the solid line of the graph.

The pressure at which the valve opens/closes and the flow rate can be optimally adjusted by adjusting the area of the valve body 204, the area of the diaphragm (movable part) 201, the length of the piston (transmission mechanism) 202, the thickness of the diaphragm (movable part) 201, and the form of the beam of the support portion 205.

In particular, when the spring constant of the diaphragm (movable part) 201 is larger than the spring constant of the support portion 205, the pressure at which the valve opens depends on the diaphragm (movable part) 201.

In contrast, when the spring constant of the support portion 205 is larger than the spring constant of the diaphragm (movable part) 201, the behavior of the valve depends on the support portion 205. The sealing property of the valve and the pressure at which the valve operates change depending on the height of a projection of the first valve 204.

The pressure P₂₂ can be adjusted by optimally determining the thickness of the spacer 213.

On the other hand, when the pressure P₂ at downstream of the valve becomes higher than a set pressure, the diaphragm (movable part) 201 bends upward to close the valve.

At this time, because the piston (transmission mechanism) 202 is not bonded to the valve body 204, the valve body 204 stops when brought into contact with the first valve seat 203. Thus, only the piston (transmission mechanism) 202 moves together with the diaphragm (movable part) 201.

This can prevent the valve from being damaged by an increase in the pressure.

Further, as shown in FIG. 13, the pressure reducing valve of this example can be structured in such a manner that the piston 202 is integrally joined to the first valve body 204, and is separated from the diaphragm 201.

In this case, the principle of the operation is also the same as that of the structure shown in FIG. 10.

As with Example 1, the opening/closing state of the valve can be confirmed by providing electrodes on the valve seat and the valve body, and providing a detection circuit for detecting the contact state between the both electrodes.

Further, the degree of the valve opening can also be confirmed by providing insulating layers on the electrode surfaces and providing a detection circuit for detecting the amount of electricity stored between the both electrodes.

The pressure reducing valve of this example can be produced, for example, using mechanical processing technology as follows.

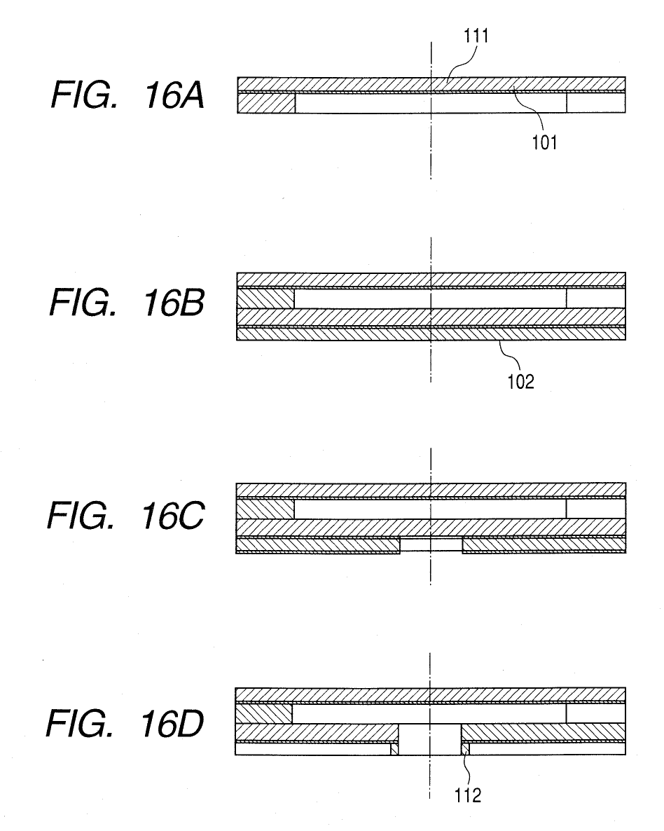

FIG. 14 is an exploded perspective view when the pressure reducing valve is viewed from the second valve seat 210 side.

As is seen from the perspective view, the pressure reducing valve is produced by stacking sheet-shaped members or plate-shaped members. The size of each member is 8 mm×8 mm.

For the diaphragm (movable part) 201, elastic materials such as Viton rubber and silicone rubber, metallic materials such as stainless steel and aluminum, plastics, or the like can be used.

For example, when stainless steel is used as a material for the diaphragm 201, the piston can be made integrally with the diaphragm 201 by etching, cutting, etc.

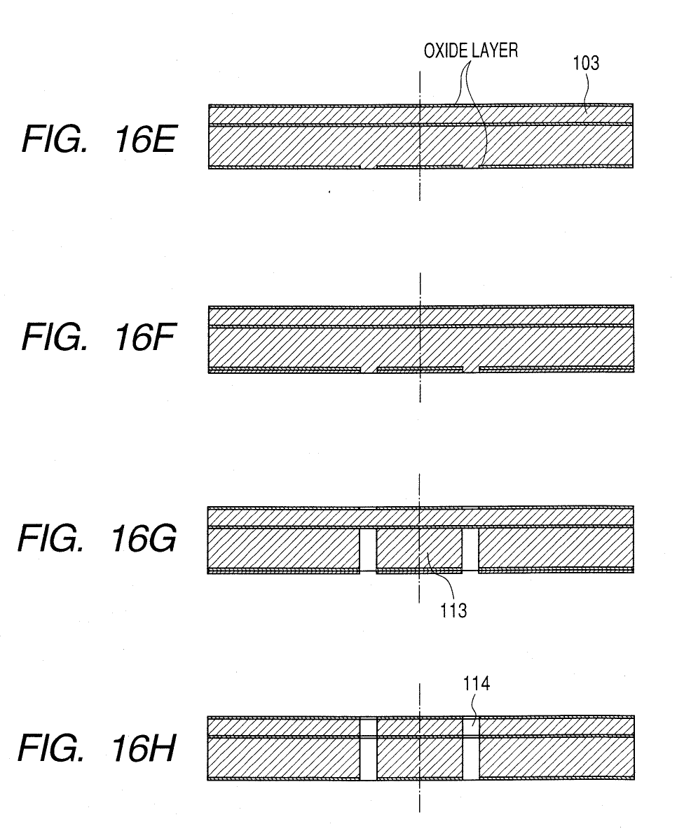

In this example, a hot melt sheet (manufactured by NITTO SHINKO CORPORATION) having a 25 μm thick adhesive layer with gas sealing property on a 50 μm thick PET base material was used for the diaphragm 201. The piston portion was made by etching a stainless steel body in which a diaphragm support portion 214 as shown in the plan view of FIG. 15A and the piston 202 were integrally formed.

The thickness of the diaphragm support portion 214 is 50 μm and the height of the piston 202 is 250 μm.

The hot melt sheets and the stainless steel member were heated in a superimposed state to about 140° C. and held at that temperature for several seconds to be adhered to each other.

A space below the lower surface of the diaphragm (movable part) 201 and a flow path through which the piston (transmission mechanism) 202 passes can be made by mechanical processing or etching of a stainless steel body.

In this example, a hot melt sheet (manufactured by NITTO SHINKO CORPORATION) having a 25 μm thick adhesive layer with gas sealing property on both sides of a 50 μm thick PET base material was used for the space below the diaphragm (movable part) 201. This is shown in the plan view of FIG. 15B.

The flow path through which the piston (transmission mechanism) 202 passes can be made by mechanical processing or etching of a stainless steel body. This is shown in the plan view of FIG. 15C.

A 250 μm thick stainless plate was etched, and the projection height of the first valve seat 203 was set to 100 μm.

Coating of the first valve seat 203 or the valve body with a sealing material may be performed by vapor depositing with Parylene or Teflon (trade names), etc.

Alternatively, the coating may be performed by applying silicone rubber, polyimide, Teflon (trade name) material, or the like, by spin coating or spraying coating.

In this example, silicone rubber was applied to the surface of both sides of a member in FIG. 15C having a valve seat by spin coating (3000 RPM×30 seconds), thereby obtaining a uniform sealing layer with a thickness of about 40 μm.

The hot melt sheet-shaped member forming the space below the movable part 201 and the stainless steel member having the flow path through which the piston (transmission mechanism) 202 passes were heated in a superimposed state to about 140° C. and held at that temperature for several seconds to be adhered to each other.

A member having the support portion 205 and the valve body 204 can be produced by mechanical processing or etching of a stainless steel body. FIG. 15D is a plan view of this member.

This member was obtained by etching a 200 μm thick stainless steel member. The thickness of the support portion 205 was 50 μm.

As materials of the spacer, metal materials such as stainless steel and resin materials can be used.

In this example, a 150 μm thick stainless steel plate was processed by etching, and both sides thereof were coated with silicone rubber by spin coating.

The coating conditions are the same as those of the first valve seat 203.

Moreover, the form and the processing method of the member having the second valve seat 210 are the same as those of the member having the first valve seat 203. The pressure reducing valve of this example can be obtained by stacking these members using mechanical processing technology.

In the production method of the pressure reducing valve of this example, two-stage stainless steel etching is frequently performed. Two-stage etching is accurately and easily performed by forming different masks on the front surface and the rear surface and by performing etching from the both sides.

The structure of the present invention is easily formed as compared with the structure of Example 1 because it is not necessary to perform multi-stage etching for forming the piston and the first valve body or the first valve seat and the second valve seat.

In the pressure reducing valve produced as described above, when the atmospheric pressure is about 1 atm, in the case where the primary pressure is equal to or more than 1 atm, the secondary pressure is about 0.8 atm (absolute pressure).

Further, the pressure reducing valve produced as described above has leakage characteristics of 0.1 sccm or less and is not damaged even when the secondary pressure is increased to 2.5 atm (absolute pressure). Further, when the primary pressure decreases, the secondary valve closes.

In this example, a hot melt sheet is used for adhesion.

This method is excellent in control of thickness or positioning. In addition to the method, a method of applying another adhesive or a method of utilizing diffusion bonding of metals is also effective.

Further, because each member is in the form of a sheet, etching and pressing are suitable for processing of a metal member, and pressing and injection molding are suitable for processing of a resin member.

Further, members made by utilizing semiconductor processing technology described in the below-mentioned examples can be used for a part or all of the members described in this example.

Next, a first method of producing the compact pressure reducing valve in this example using semiconductor processing technology will be described.

The compact pressure reducing valve produced according to this example has a structure such that the piston (transmission mechanism) is integrally formed with the valve body and is separated from the diaphragm (movable part) as shown in FIG. 13.

The dimension of each part of the compact pressure reducing valve produced in this example can be set as follows, but can be changed according to designs.

The diaphragm (movable part) can be adjusted to be 3.6 mm in diameter and 40 μm in thickness.

The piston (transmission mechanism) can be adjusted to be 260 μm in diameter and 200 to 400 μm in length.

The piston passing flow path can be adjusted to be 400 μm in diameter.

The projection can be adjusted to be 20 μm in width and 10 μm in height, the sealing layer can be adjusted to be 5 μm in thickness, and the valve body can be adjusted to be 1000 μm in diameter and 200 μm in thickness.

The support portion can be adjusted to be 1000 μm in length, 200 μm in width, and 10 μm in thickness.

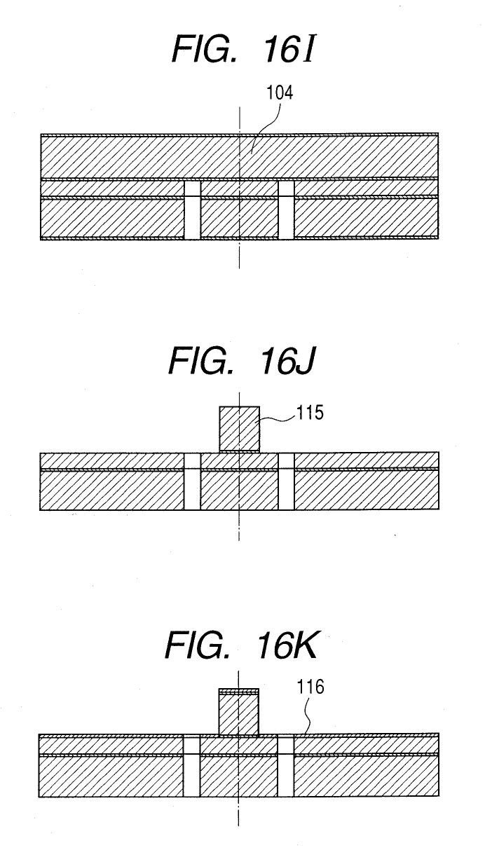

Next, production steps of the first method in this example will be described in detail. FIGS. 16A to 16Q are views illustrate the steps of the production procedure of the compact pressure reducing valve of this example.

A first step shown in FIG. 16A is a step of making a diaphragm (movable part) using a first silicon wafer 101.

A silicon wafer having one side thereof polished is also usable for the wafer. However it is desirable to use a silicon wafer having both sides thereof polished.

Further, in an etching step below, in order to control the etching depth, it is desirable to use a silicon-on-insulator (SOI) wafer.

For the silicon wafer, for example, a silicon wafer having a 200 μm thick handle layer, a 1 μm thick oxide layer (BOX layer), and a 40 μm thick device layer can be used.

An etching mask is formed on the first wafer 101. Etching is performed by about 200 μm in depth using reactive ion etching (ICP-RIE).

In this case, a thick photoresist with a thickness of 1 μm or more, a metal film such as aluminum, or a silicon oxide layer which is obtained by thermally oxidizing the wafer surface can be used for the mask. In the case of using a silicon oxide layer for the mask, for example, the first wafer is placed in a furnace and hydrogen and oxygen are flowed at predetermined flow rates in the furnace heated to about 1000° C. to thereby form an oxide layer on the wafer surface.

Next, a photoresist is spin coated on the wafer surface, pre-baked, and exposed to light.

Further, development and post-baking are performed. Using the photoresist as the mask, an oxide layer is etched with hydrofluoric acid.

Using the mask thus obtained, a diaphragm (movable part) 111 is formed by reactive ion etching (ICP-RIE).

The etching depth may be controlled by adjusting the etching time, or an oxide layer (BOX layer) of an SOI wafer may be used as an etch stop layer.

After the etching, the silicon oxide layer used for the mask is removed with hydrofluoric acid.

A second step shown in FIG. 16B is a direct-bonding step of wafers. The surface of another silicon wafer (second silicon wafer) 102 is thermally oxidized.

It is desirable to use a silicone wafer having both sides thereof polished for the second silicon wafer.

Further, in an etching step below, in order to control the depth of a projection of a first valve seat 112, it is desirable to use a silicon-on-insulator (SOI) wafer.

For the silicon wafer, for example, a silicon wafer having a 200 μm thick handle layer, a 1 μm thick oxide layer (BOX layer), and 5 μm thick device layer can be used. The thermal oxidation process is the same as in the first process. Next, the first wafer 101 and the second wafer 102 are washed with SPM (washed in a mixed liquid of hydrogen peroxide solution and sulfuric acid heated at 80° C.), and then washed with dilute hydrofluoric acid.

The first wafer 101 and the second wafer 102 are superimposed on each other, and the sample is heated to 1100° C. within 3 hours while pressurized at about 1500 N. The resultant is held at that temperature for 4 hours and is then naturally cooled to perform annealing.

A third step shown in FIG. 16C is a step of forming the flow path for allowing the piston (transmission mechanism) to pass therethrough.

In order to perform two-stage etching in this step and the subsequent step, a mask with a two-layer structure having a silicon oxide layer and a photoresist layer is prepared.

First, a photoresist is spin coated on the rear surface, pre-baked, and exposed to light, and then patterning for forming the first valve seat 112 is performed.

Further, development and post-baking are performed. Using the photoresist as the mask, the oxide layer is etched with hydrofluoric acid.

Further, a mask for forming the flow path is patterned. More specifically, a photoresist is spin coated on the rear surface, pre-baked, exposed to light, developed, and post-baked.

Then, the flow path is formed by reactive ion etching (ICP-RIE). When an SOI wafer is used, etching is performed to a middle oxide layer, and then an oxide layer is removed with hydrofluoric acid.

The photoresist used for the mask is removed with acetone.

A fourth step shown in FIG. 16D is a step of forming the first valve seat 112 by reactive ion etching (ICP-RIE) using the mask for forming the first valve seat 112 prepared in the previous step.

When an SOI wafer is used, a middle oxide layer can be used as an etch stop layer whereby the height of the projection of the first valve seat can be precisely adjusted and the front surface after the etching can be kept flat.

After the etching, the silicon oxide layer used for the mask is removed with hydrofluoric acid.

In this example, the photoresist and the silicon oxide layer were used as a two-layer mask. However, this process can be performed by using silicon oxide layers having different thicknesses, or by using an aluminum layer.

A fifth step shown in FIG. 16E is a step of making a mask for forming a first valve body 113 using a third wafer 103.

A silicon wafer having one side thereof polished is usable for the wafer. However, it is desirable to use a silicon wafer having both sides thereof polished.

Further, in the below-mentioned etching step, in order to control the etching depth, it is desirable to use a silicon-on-insulator (SOI) wafer.

For the silicon wafer, a silicon wafer having a 200 μm thick handle layer, a 1 μm thick oxide layer (BOX layer), and a 10 μm thick device layer can be used.

First, the third silicon wafer 103 is thermally oxidized. The thermal oxidization is performed by placing the first layer in a furnace and hydrogen and oxygen are flowed at predetermined flow rates in the furnace heated to about 1000° C.

Next, the oxide layer on the front surface is protected by a photoresist, and then the oxide layer on the rear surface is patterned. A photoresist is spin coated on the rear surface of the wafer, pre-baked, and exposed to light. Further, development and post-baking are performed. Using the photoresist as the mask, the oxide layer is etched with hydrofluoric acid, thereby performing patterning for forming the valve seat.

After the patterning, the photoresist on each of the front surface and rear surface is removed with acetone.

A sixth step shown in FIG. 16F is a step of preparing a mask for forming a support portion 114.

First, the oxide layer on the rear surface is protected by a photoresist, and then the oxide layer on the front surface is patterned.

A photoresist is spin coated on the front surface of the wafer, pre-baked, and exposed to light. Further, development and post-baking are performed. Using the photoresist as the mask, the oxide layer is etched with hydrofluoric acid, thereby performing patterning for forming the support portion.

After the patterning, the photoresists on the front surface and rear surface are removed with acetone.

A seventh step shown in FIG. 16G is a step of forming a valve body.

The rear surface of the wafer is etched by reactive ion etching (ICP-RIE).

The etching depth may be controlled by adjusting the etching time, or an oxide layer (BOX layer) of an SOI wafer may be used as an etch stop layer.

An eighth step shown in FIG. 16H is a step of forming a support portion.

The wafer surface is etched by reactive ion etching (ICP-RIE).

When an SOI wafer is used, the thickness of the support portion can be precisely controlled at this time. Therefore, a support portion with less spring constant error can be obtained.

After the etching, the oxide layer used for the mask is removed with hydrofluoric acid.

A ninth step shown in FIG. 16I is a step of bonding a fourth wafer 104 to the third wafer 103.

It is desirable to use a wafer having both sides thereof polished. The thickness of the wafer is selected according to the height of the piston (transmission mechanism), for example, a 400 μm thick piston can be used.

The front surface of the fourth wafer 104 is oxidized by thermal oxidation.

Next, the third wafer 103 and the fourth wafer 104 are washed with SPM (washed in a mixed liquid of hydrogen peroxide solution and sulfuric acid heated at 80° C.), and then washed with dilute hydrofluoric acid.

The third wafer 103 and the fourth wafer 104 are superimposed on each other, and the sample is heated to 1100° C. within 3 hours while pressurized at about 1500 N. The resultant is held at that temperature for 4 hours, and then naturally cooled to be annealed.

A tenth step shown in FIG. 16J is a step of forming a transmission mechanism 115.

First, an etching mask is patterned. The silicon oxide layer on the wafer surface is used for the mask.

Next, etching is performed by reactive ion etching (ICP-RIE), and a transmission mechanism is formed. Etching stops at the silicon oxide layer of the bonding surfaces.

An eleventh step shown in FIG. 16K is a step of coating of a sealing surface. As shown in FIG. 16K, the coating may be performed either on the valve body side or on the valve seat side. Examples of a coating material include Parylene, CYTOP, polytetrafluoroethylene (PTFE), polyimide, etc.

Parylene and PTFE can be applied by vapor deposition and CYTOP and polyimide can be applied by spin coating. In addition, spray coating can also be used.

A twelfth step shown in FIG. 16L is a mask patterning step for etching.

A silicon wafer having one side thereof polished is usable for a fifth silicon wafer 105. However it is desirable to use a silicon wafer having both sides thereof polished.

Further, in the below-mentioned etching step, in order to control the etching depth, it is desirable to use a silicon-on-insulator (SOI) wafer.

In particular, it is preferable to use a double SOI wafer with two oxide layers.

A silicon wafer having a 300 μm thick silicon layer, a 1 μm thick oxide layer (BOX layer), a 5 μm thick silicon layer, a 1 μm thick oxide layer (BOX layer), and 10 μm thick silicon layer is used in which the layers are stacked in the above-mentioned order in the upward direction in the figure.

For use as an etching mask, the front surface of the fifth wafer 105 is thermally oxidized.

The first layer is placed in a furnace and hydrogen and oxygen are flowed at predetermined flow rates in the furnace heated to about 1000° C. to thereby form an oxide layer on the wafer surface.

Next, the oxide layer on the front surface of the wafer is protected by a photoresist. Then, patterning of the oxide layer on the rear surface of the wafer is performed. The photoresist is spin coated on the rear surface of the wafer, pre-baked, and exposed to light.

Further, development and post-baking are performed. The oxide layer is etched with hydrofluoric acid using the photoresist as a mask, thereby performing patterning for forming an inlet flow path 117. After the patterning, the photoresists on the front surface and rear surface are removed with acetone.

A thirteenth step shown in FIG. 16M is a step of forming the inlet flow path 117.

The rear surface of a wafer is etched by reactive ion etching (ICP-RIE).

The etching depth may be controlled by using an oxide layer (BOX layer) of an SOI wafer as an etch stop layer.

A fourteenth step shown in FIG. 16N is a step of patterning and forming a second valve seat 120.

In order to perform two-stage etching in this step and the subsequent step, a mask with a two-layer structure having a silicon oxide layer and a photoresist layer is prepared.

The photoresist is spin coated, pre-baked, and exposed to light. Then, patterning for forming a spacer 121 is performed.

Further, development and post-baking are performed. The oxide layer is etched with hydrofluoric acid using the photoresist as a mask.

Further, a mask for forming the second valve seat 120 is patterned.

More specifically, a photoresist is spin coated, pre-baked, exposed to light, developed, and post-baked.

In this example, the photoresist and the silicon oxide layer were used as a two-layer mask. However, this step can be performed by using silicon oxide layers having different thicknesses, or by using an aluminum layer.

The second valve seat 120 is formed by reactive ion etching (ICP-RIE).

A fifteenth step shown in FIG. 16O is a step of forming the spacer 121.

A wafer is etched by reactive ion etching (ICP-RIE). The silicon oxide layer used for the mask is removed with hydrofluoric acid.

A sixteenth step shown in FIG. 16P is a step of coating of a sealing surface.

Examples of the coating material include Parylene, CYTOP, polytetrafluoroethylene (PTFE), polyimide, etc.

Parylene and PTFE can be applied by vapor deposition and CYTOP and polyimide can be applied by spin coating. In addition, spray coating can also be used.

A seventeenth step shown in FIG. 16Q is an assembling step.

A compact pressure reducing valve is completed by stacking the member having the diaphragm (movable part) 111 and the first valve seat 112, the member having the transmission mechanism 115 and the first valve body 113, and the second valve seat 120.

In this example, bonding is performed using diffusion-bonding technology of silicon. However, the pressure reducing valve produced in this example does not require high strength for bonding of the piston (transmission mechanism).

Therefore, a method of forming metal films on bonding surfaces in advance, and then bonding the metals with each other, and a method using an adhesive, can also be used.

Next, a second method of producing, using semiconductor processing technology, the compact pressure reducing valve of this example will be described.

The compact pressure reducing valve produced according to this example has a structure such that the piston (transmission mechanism) is integrally joined to the diaphragm (movable part) and is separated from the valve body as shown in FIG. 10.

When compared with Example 1, because the number of times of bonding steps is reduced from twice to once, the yield and throughput can be improved.

Further, because the number of wafers can be reduced from four to three, the production cost can also be reduced.

In addition, as described below, the second production method is also advantageous in that the shape of a diaphragm (movable part) is formed into a doughnut shape which has a support portion at the center, thereby optimizing the rigidity of the diaphragm (movable part).

The dimension of each part of the compact pressure reducing valve produced in this example, for example, can be set as follows, but can be changed according to designs.

The diaphragm (movable part) can be adjusted to be 3.6 mm in diameter and 40 μm in thickness.

The piston (transmission mechanism) can be adjusted to be 260 μm in diameter and 200 to 400 μm in length.

The piston passing flow path can be adjusted to be 400 μm in diameter.

The projection can be adjusted to be 20 μm in width and 10 μm in height, the sealing layer can be adjusted to be 5 μm in thickness, and the valve body can be adjusted to be 1000 μm in diameter and 200 μm in thickness.

The support portion can be adjusted to be 1000 μm in length, 200 μm in width, and 10 μm in thickness.

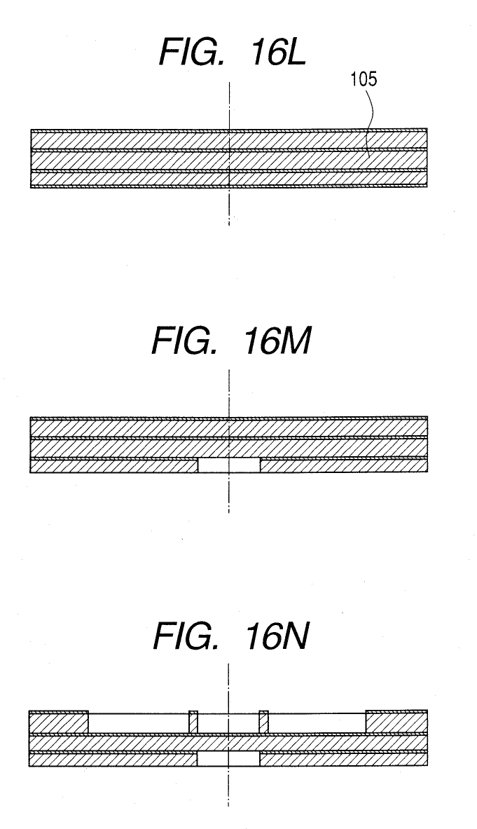

Next, the specific production steps of the second method of producing a compact pressure reducing valve according to this example will be described with reference to FIG. 17A to 17K.

A first step shown in FIG. 17A is a mask patterning step for etching.

A silicon wafer having one side thereof polished is also usable for a first silicon wafer 101. However, it is desirable to use a silicon wafer having both sides thereof polished.

Further, in the below-mentioned etching step, in order to control the etching depth, it is desirable to use a silicon-on-insulator (SOI) wafer.

For the silicon wafer, a silicon wafer having a 300 μm thick handle layer, a 1 μm thick oxide layer (BOX layer), and a 50 μm thick device layer can be used by turning over the silicon wafer so that the handle layer faces upward in the figure.

For use as an etching mask, the surface of the first wafer 101 is thermally oxidized.

The first wafer is placed in a furnace and hydrogen and oxygen are flowed at predetermined flow rates in the furnace heated to about 1000° C. to thereby form an oxide layer on the wafer surface.

Next, in order to perform two-stage etching in this step and the subsequent step, a mask with a two-layer structure having a silicon oxide layer and a photoresist layer is prepared.

Then, the photoresist is spin coated, pre-baked, and exposed to light. Then, patterning for forming a flow path below the lower surface of the diaphragm (movable part) is performed.

Further, development and post-baking are performed. The oxide layer is etched with hydrofluoric acid using the photoresist as a mask. Further, a mask for forming the transmission mechanism 115 is patterned.

More specifically, the photoresist is spin coated, pre-baked, exposed to light, developed, and post-baked.

In this example, the photoresist and the silicon oxide layer were used as a two-layer mask. However, this step can be performed by using silicon oxide layers having different thicknesses, or by using an aluminum layer.

A second step shown in FIG. 17B is a step of forming a piston (transmission mechanism) by reactive ion etching (ICP-RIE).

The etching depth is controlled by adjusting the etching time, and etching of about 150 μm is performed. Finally, the photoresist mask is removed with acetone.

A third step shown in FIG. 17C is a step of forming a flow path below the diaphragm (movable part).

A wafer is etched by reactive ion etching (ICP-RIE).

The etching depth may be controlled by adjusting the etching time, or an oxide layer (BOX layer) of an SOI wafer may be used as an etch stop layer as shown in figure.

The silicon oxide layer used for the mask is removed with hydrofluoric acid.

A fourth step shown in FIG. 17D is a direct bonding step of wafers. It is desirable to use a silicon wafer having both sides thereof polished for the second silicon wafer.

Further, in the below-mentioned etching step, in order to control the height of the first valve seat 112, it is desirable to use a silicon-on-insulator (SOI) wafer.

A silicon wafer with a 200 μm thick handle layer, a 1 μm thick oxide layer (BOX layer), and a 40 μm thick device layer is mentioned as an example of the silicon wafer, and the device layer is used as the diaphragm (movable part).

When using a silicon oxide as an etching mask in the below-mentioned etching process, thermal oxidation is performed similarly as in the first step.

Next, the first wafer 101 and the second wafer 102 are washed with SPM (washed in a mixed liquid of hydrogen peroxide solution and sulfuric acid heated at 80° C.), and then washed with diluted hydrofluoric acid.

The first wafer 101 and the second wafer 102 are superimposed on each other, and the sample is heated to 1100° C. within 3 hours while pressurized at about 1500 N. The resultant is held at that temperature for 4 hours and then naturally cooled to be annealed.

A fifth step shown in FIG. 17E is a step of forming the diaphragm (movable part).

A wafer is etched by reactive ion etching (ICP-RIE). The etching depth may be controlled by adjusting the etching time, or an oxide layer (BOX layer) of an SOI wafer may be used as an etch stop layer as shown in figure.

The shape of the diaphragm (movable part) may be circular. Alternatively, as shown in the figures, a doughnut-shaped diaphragm or a diaphragm with a beam may also be used.

A sixth step shown in FIG. 17F is a step for forming the first valve seat 112.

For a mask, besides a thick film photoresist, a silicon oxide layer, aluminum, etc., can be used.

A photoresist is spin coated on a wafer surface, pre-baked, and exposed to light. When using a material other than photoresist for the mask, a mask layer is patterned by etching.

Etching is performed by reactive ion etching (ICP-RIE) to thereby form the first valve seat 112.

When an SOI wafer is used for the first wafer 101, a middle oxide layer can be used as an etch stop layer, the height of the projection of the valve seat can be precisely adjusted, and the front surface after etching can be kept flat.

The mask is removed after the etching.

A seventh step shown in FIG. 17G is a mask patterning step for etching using the third silicon wafer 103.

A silicon wafer having one side thereof polished is usable for the third silicon wafer 103. However it is desirable to use a silicon wafer having both sides thereof polished.

Further, in the below-mentioned etching step, in order to control the etching depth, it is desirable to use a silicon-on-insulator (SOI) wafer.

For the silicon wafer, a silicon wafer having a 200 μm thick handle layer, a 1 μm thick oxide layer (BOX layer), and a 10 μm thick device layer can be used.

For use in an etching mask, the surface of the third wafer 103 is thermally oxidized.

The third wafer is placed in a furnace and hydrogen and oxygen are flowed at predetermined flow rates in the furnace heated to about 1000° C. to thereby form an oxide layer on the wafer surface.

Next, the front surface of the wafer is protected by a photoresist, and then, patterning for forming the valve body on the rear surface is performed. Subsequently, the photoresist is spin coated, pre-baked, and exposed to light.

Further, development and post-baking are performed. The oxide layer is etched with hydrofluoric acid using the photoresist as a mask.

The photoresists on the front surface and the rear surface are removed with acetone. In this step, photoresist or aluminum can be used for a mask besides a silicon oxide.

An eighth step shown in FIG. 17H is a step of preparing a mask for forming a support portion 114.

The rear surface of the wafer is protected by a photoresist, and then, patterning for forming the support portion on the front surface of the wafer is performed.

The photoresist is spin coated, pre-baked, and exposed to light.

Further, development and post-baking are performed. Using the photoresist as the mask, the oxide layer is etched with hydrofluoric acid. The photoresists on the front surface and rear surface are removed with acetone.

A ninth step shown in FIG. 17I is a step of forming a first valve body 113. The rear surface of a wafer is etched by reactive ion etching (ICP-RIE).

The etching depth may be controlled by adjusting the etching time, or an oxide layer (BOX layer) of an SOI wafer may be used as an etch stop layer.

A tenth step shown in FIG. 17J is a step of forming a support portion.

The front surface of a wafer is etched by reactive ion etching (ICP-RIE).

When an SOI wafer is used, the thickness of a support portion can be precisely controlled at this time, so that a support portion with less spring constant error can be obtained. After the etching, the oxide layer used for the mask is removed with hydrofluoric acid.

An eleventh step shown in FIG. 17K is a step of coating of a sealing surface. As shown in FIG. 17K, the coating may be performed either on the valve body side or on the valve seat side.

Examples of a coating material include Parylene, CYTOP, polytetrafluoroethylene (PTFE), polyimide, etc.

Parylene and PTFE can be applied by vapor deposition and CYTOP and polyimide can be applied by spin coating.

In addition, spray coating can also be used.

The steps subsequent to the above described steps are the same as those shown in FIGS. 16L to 16Q.

### Example 3

In Example 3, a fuel cell with the compact pressure reducing valve of the present invention is described.

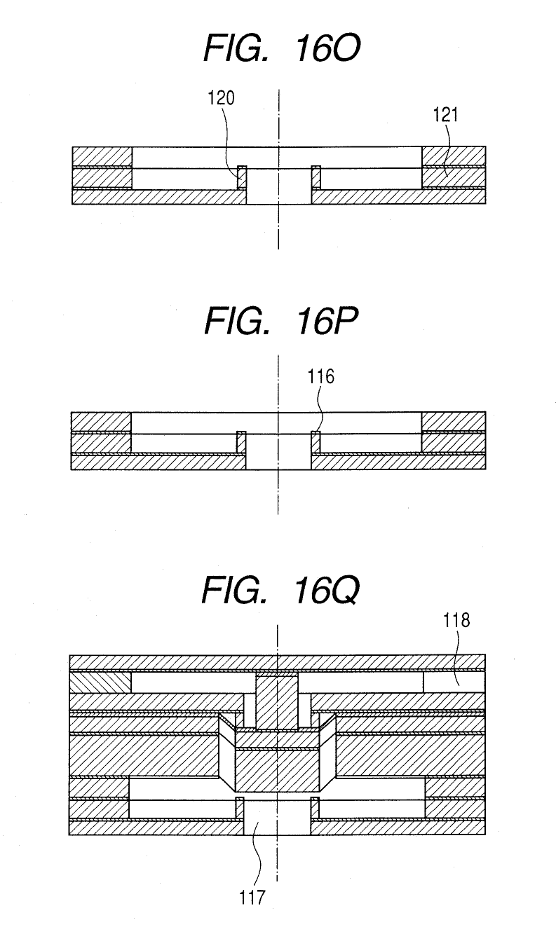

FIG. 18 is a perspective view illustrating a fuel cell of the present invention.

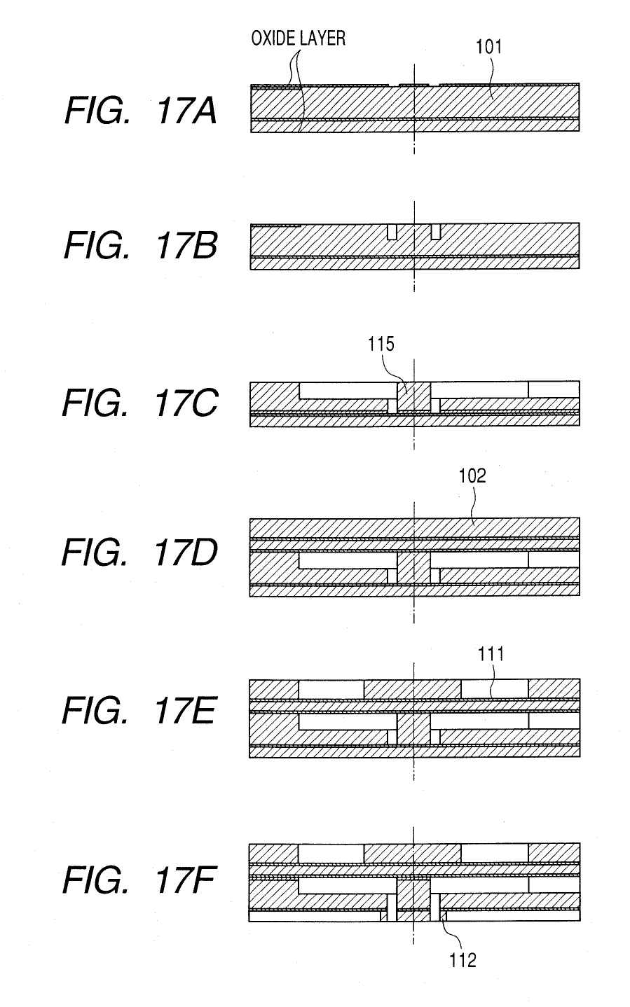

FIG. 19 schematically illustrates a fuel cell system of the present invention.

The external dimension of the fuel cell of this example is 50 mm×30 mm×10 mm, and is almost the same dimension as that of a lithium ion battery usually used in a compact digital camera.

As described above, because the fuel cell of this example is compact and is integrally assembled, the shape thereof is easy to be incorporated into a portable device.

The fuel cell of this example takes in oxygen as an oxidizer for use in a reaction from the outside air, so air holes 133 for taking in the outside air are provided on the upper surface, lower surface, and side surfaces.

This air hole releases the generated water as steam, or releases the heat generated by a reaction outside. The inside of the fuel cell includes a fuel cell unit 131 including an oxidizer electrode 136, a polymer electrolyte membrane 137, a fuel electrode 138; a fuel tank 134 which stores fuel; and a compact pressure reducing valve 135 in which the fuel tank is connected to the fuel electrode of each cell, thereby controlling the flow rate of fuel.

Next, the fuel tank 134 will be described.

The inside of the tank is filled with hydrogen storage alloy which can occlude hydrogen. Based on the fact that the pressure resistance of a polymer electrolyte membrane for use in a fuel cell is 0.3 to 0.5 MPa, the differential pressure between the outside air and the inside of the tank needs to be equal to or less than 0.1 MPa.

For example, LaNi₅ and the like are used as a hydrogen storage alloy having a hydrogen release pressure of 0.2 MPa at ordinary temperature.

When the volume of the fuel tank is made half of the entire volume of the fuel cell; the tank wall thickness is adjusted to 1 mm; and titanium is used as a material of the tank, the weight of the fuel tank is about 50 g and the volume of the fuel tank is 5.2 cm³.

When hydrogen storage material having a hydrogen release pressure exceeding 0.2 MPa at ordinary temperature is placed in the tank of this example, it is necessary to provide the compact pressure reducing valve 135 between the fuel tank 134 and the fuel electrode 138 for reducing a pressure.

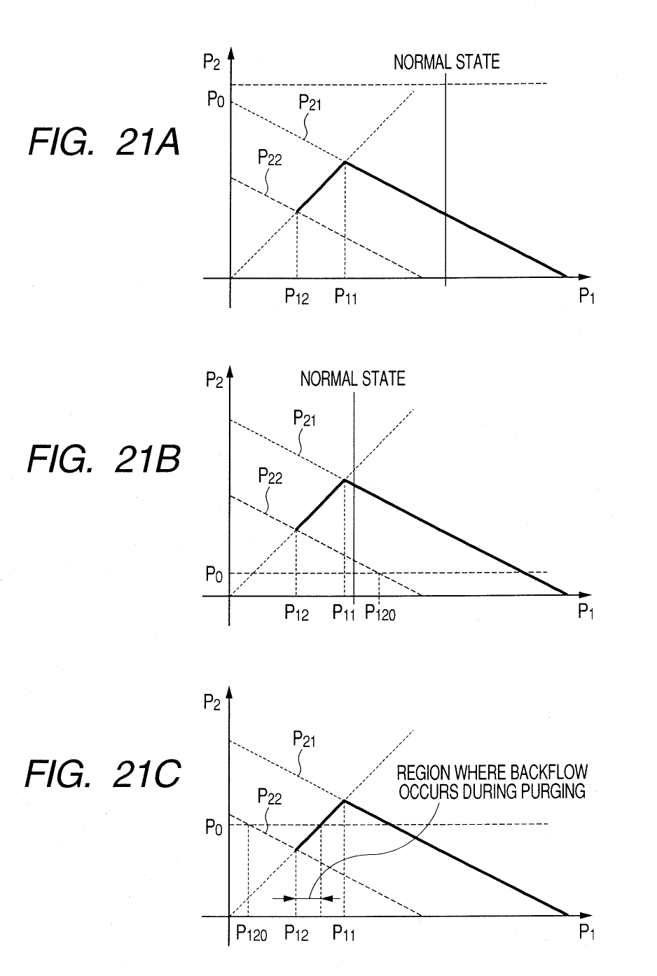

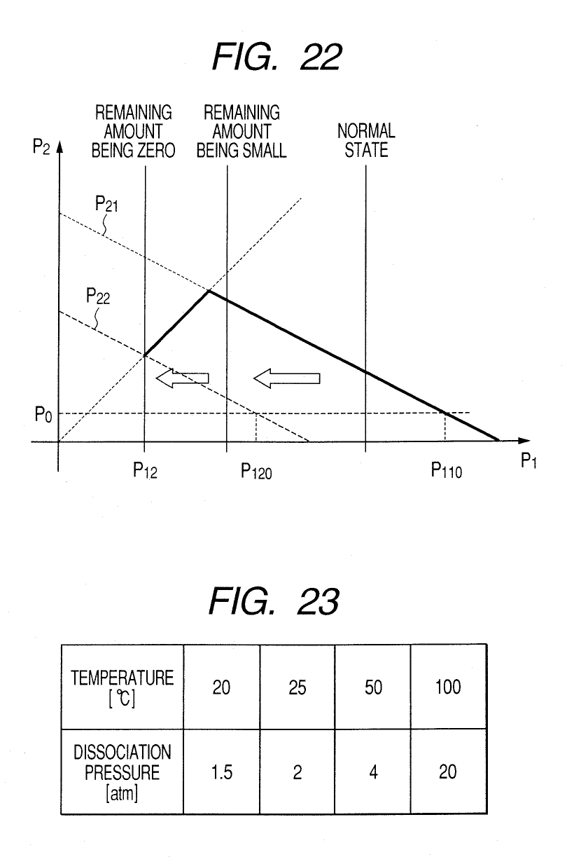

For example, LaNi₅ can absorb and desorb 1.1 wt % of hydrogen per weight. The dissociation pressure at each temperature of LaNi₅ is illustrated in FIG. 23. The hydrogen stored in the tank is depressurized with the compact pressure reducing valve 135, and is supplied to the fuel electrode 138.

The outside air is supplied by the air hole 133 to the oxidizer electrode 136. The electricity generated by the fuel cell unit is supplied to a compact electrical machinery and apparatus by the electrode 132.

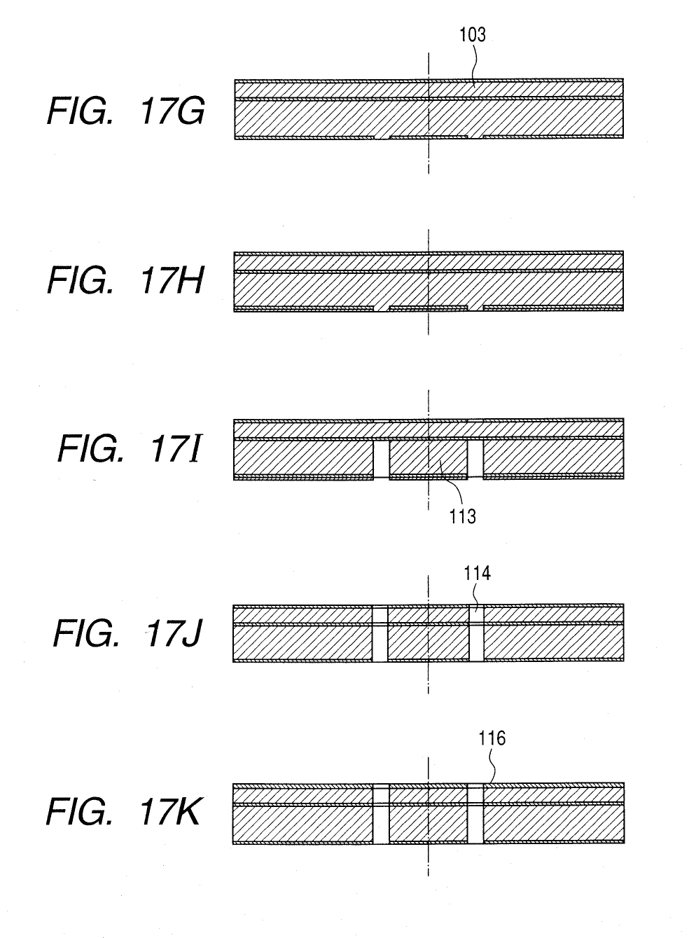

FIG. 20 is a view illustrating the positional relationship when the compact pressure reducing valve having the structure of Example 2 is mounted onto a fuel cell.

The primary side of the compact pressure reducing valve is connected to the fuel tank 134. An outlet flow path 208 is connected to the fuel electrode 138 and the outlet flow path and opposite side of the diaphragm (movable part) 201 are in contact with the oxidizer electrode (outside air).

The size of the entire valve is about 10 mm×10 mm×1 mm.

As described above, by realizing such a compact valve mechanism, a mechanism for controlling a fuel flow rate can be incorporated into a compact fuel cell.

Hereinafter, an open/closing operation of the valve in the power generation of the fuel cell will be described.

While the power generation is stopped, the compact pressure reducing valve 135 remains closed.

When power generation is started, the fuel in the fuel electrode chamber is consumed, whereby the pressure inside the fuel of the fuel electrode chamber decreases.

The diaphragm (movable part) 201 bends toward the fuel electrode chamber by a differential pressure between the external atmospheric pressure and the pressure in the fuel electrode chamber, and the action of the diaphragm (movable part) 201 is transmitted to the valve body 204 via the piston 202, to thereby open the valve.

Thereby, the fuel is supplied to the fuel electrode chamber 138 from the fuel tank 134. When the power generation is stopped, the fuel is not consumed, so that the pressure in the fuel electrode chamber is increased, whereby the diaphragm (movable part) 201 is pushed up to thereby close the valve body 204.

The pressure in the fuel tank 134 changes depending on the ambient temperature and the remaining amount of fuel.

When the pressure in the fuel tank 134 changes, the secondary pressure after pressure reduction also changes as indicated by the thick line in FIG. 4.

In the fuel cell of the present example, for the purpose of size reduction, there is used the dead-ended system in which fuel is not circulated, unlike a large fuel cell, and fuel in an amount equal to the amount of consumed fuel is supplied from the fuel tank 134. However, in the fuel cell of the dead-ended system, when impurity such as nitrogen and water vapor is accumulated in the fuel electrode chamber, the power generation characteristics are deteriorated. Therefore, it is necessary to frequently perform purging.

The purging is performed by opening and closing a purge valve 139.

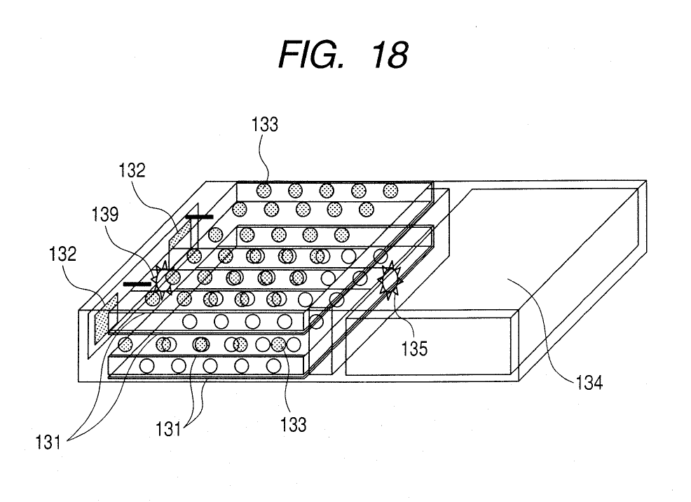

During purging, the pressure P₂ of the fuel electrode chamber becomes the outside air pressure P₀. Therefore, in order to perform purging effectively, the pressure P₂ during normal operation needs to be higher than the outside air pressure P₀. Otherwise, the outside air flows backward into the fuel electrode chamber (the state shown in FIG. 21A).

Further, in a case where the working pressure P₂₂ of the second valve during normal operation is higher than the outside air pressure P₀, the second valve closes at the timing of purging, which makes it impossible to supply fuel required for purging from the fuel tank (the state shown in FIG. 21B).

On the other hand, in a case where the working pressure P₂₂ of the second valve is lower than the outside air pressure P₀ during normal operation, when the pressure P₁ of the fuel tank is lower than the outside air pressure P₀ at the time of purging, the outside air flows backward into the fuel tank 134 (the state shown FIG. 21C).

Therefore, when a pressure reducing valve of the present invention is mounted on a fuel cell, it is necessary to set the pressures P₂₁ and P₂₂ as follows.

More specifically, for the primary pressure P₁ of the tank in a normal operation state, the pressures are set in such a manner as to satisfy the relationship of P₂₁>P₂₂>P₀ Moreover, for the pressure P₁=P₁₂₀ when the remaining fuel amount in the tank decreases, the pressures are set in such a manner as to satisfy the relationship of P₁>P₂₂=P₀.

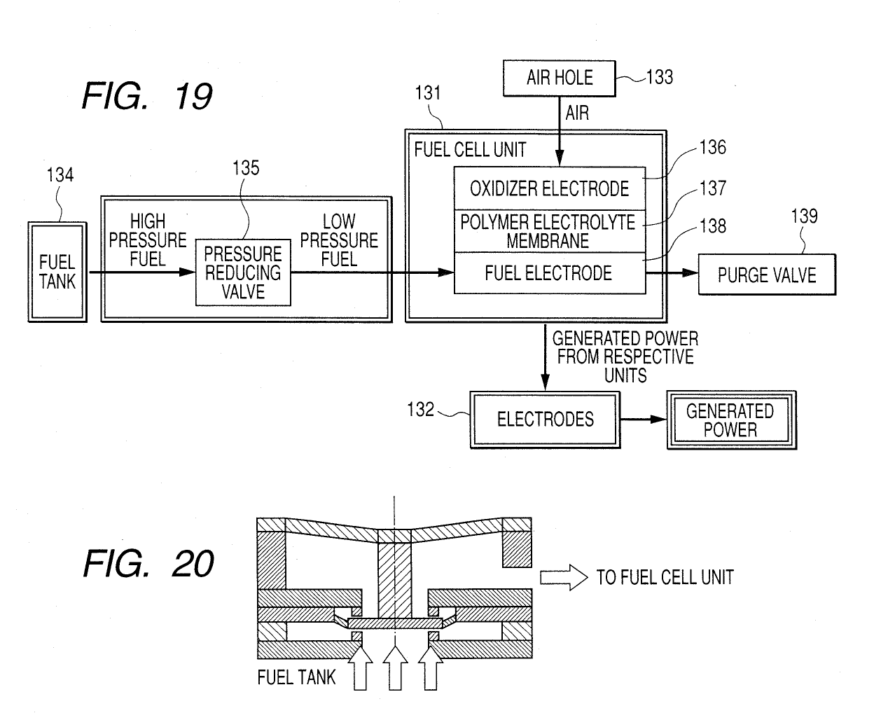

A state which satisfies these conditions is shown in FIG. 22. First, at the time of normal operation, the secondary pressure P₂ is equal to the pressure P₂₁ which is higher than the outside air pressure P₀.

When purging is performed at this time, the secondary pressure P₂ decreases to P₀, but, because of P₂₂<P₀, purging can be performed without closing the second valve.

On the other hand, when the pressure P₁ of the fuel tank 134 falls to the level indicated by “REMAINING AMOUNT BEING SMALL” in the figure as the fuel is consumed, the second valve closes because of P₂₂>P₀ being established in this pressure area, so that even when purging is attempted, purging is not performed, whereby the outside air is prevented from mixing into the fuel tank 134.

Further, when the fuel is consumed and the pressure in the fuel tank falls to the state indicated by “REMAINING AMOUNT BEING ZERO” in the figure, P₂=P₂₂ is established, whereby the second valve closes to stop the power generation.

At that time, by providing a detection circuit as described in Examples 1 and 2, a user can be notified of the remaining fuel amount in the tank, or an electronic device can be suspended safely.

As described in detail in the above examples, according to the valve structures and valve production methods of the present invention, it is possible to achieve a pressure reducing valve which is very compact, is excellent in sealing characteristics and durability, and has a counterflow prevention function.

Moreover, by using such a compact pressure reducing valve for controlling a compact fuel cell, impurity gas can be prevented from mixing into a fuel vessel when the pressure in the fuel vessel falls, and also a fuel cell system can be reduced in size.

While the present invention has been described with reference to exemplary examples, it is to be understood that the invention is not limited to the disclosed exemplary examples. The scope of the following claims is to be accorded the broadest interpretation so as to encompass all such modifications and equivalent structures and functions.

This application claims the benefit of Japanese Patent Application No. 2006-232851, filed Aug. 29, 2006, which is hereby incorporated by reference herein in its entirety.

1. A pressure control valve comprising:
a movable part which operates by a differential pressure;
a first valve for reducing a primary pressure to a secondary pressure;
a second valve which operates to block a flow path between an inlet flow path and an outlet flow path for discharging the secondary pressure when the first valve operates to open the inlet flow path for introducing a fluid having the primary pressure; and
a transmission mechanism which links the operation of the movable part with the operations of the first and the second valves,
wherein either one of the movable part and the first valve is separated from the transmission mechanism.

2. The pressure control valve according to claim 1, wherein the first valve comprises a first valve seat, a first valve body, and a support portion for supporting the first valve body so as to create or close a gap between the first valve body and the first valve seat in accordance with an action of the movable part transmitted by the transmission mechanism.

3. The pressure control valve according to claim 2, wherein the support portion for supporting the first valve body comprises an elastic body for supporting the first valve body provided on a flat plane which is perpendicular to a direction of an action of the transmission mechanism and includes the first valve body.

4. The pressure control valve according to claim 1, wherein the second valve is located upstream of the first valve in the flow path.

5. The pressure control valve according to claim 4, wherein the second valve is constituted by providing a second valve seat upstream of the first valve in the flow path.

6. The pressure control valve according to claim 1, wherein the movable part is a diaphragm.

7. The pressure control valve according to claim 1, which is constituted by stacking the first valve and the second valve, the movable part, and the transmission mechanism each formed of a sheet-shaped member or a plate-shaped member.

8. A method of producing a pressure control valve comprising a movable part which operates by a differential pressure, a first valve for reducing a primary pressure to a secondary pressure, a second valve which operates to block a flow path between an inlet flow path and an outlet flow path for discharging the secondary pressure when the first valve operates to open the inlet flow path for introducing a fluid having the primary pressure, and a transmission mechanism which links the operation of the movable part with the operations of the first and the second valves, either one of the movable part and the first valve being separated from the transmission mechanism, the method comprising:
forming a movable part using one of a sheet-shaped member and a plate-shaped member;
forming a transmission mechanism using one of a sheet-shaped member and a plate-shaped member;
forming a first valve and a second valve using a sheet-shaped member or a plate-shaped member; and
stacking the above formed components on one another to assemble a pressure control valve.

9. The method according to claim 8, wherein a semiconductor substrate is used in at least a part of one of the sheet-shaped member and the plate-shaped member.

10. The method according to claim 8, wherein at least one structure forming process selected from etching and pressing and at least one assembling process selected from bonding and adhesion are used in the movable part formation, the transmission mechanism formation, the first and second valve formation, and the assembling.

11. A fuel cell system comprising:
a fuel vessel;
a fuel cell power generation part;
a fuel flow path provided therebetween, for supplying fuel from the fuel vessel to the fuel cell power generation part, and
a pressure control mechanism provided in the fuel flow path,
wherein one of the pressure control valve set forth in claim 1 is mounted as the pressure control mechanism.

12. A method of controlling pressure of the pressure control valve in the fuel cell system set forth in claim 11, which comprises adjusting a working pressure of the second valve in accordance with a set pressure of the fuel vessel.

13. The method according to claim 12, wherein control is performed such that when the primary pressure is a pressure in a normal operation state of the fuel vessel, the secondary pressure is higher than an outside air pressure.

14. A method of controlling pressure according to claim 12, wherein control is performed such that in a case where the primary pressure is higher than a predetermined pressure, when the secondary pressure is made equal to an outside air pressure, the second valve is in an open state, while in a case where the primary pressure is lower than the predetermined pressure, when the secondary pressure is made equal to the outside air pressure, the second valve is in a closed state.
